(19) United States
(12) Patent Application Publication
(10) Pub. No.: US 2009/0069476 A1
(43) Pub. Date: Mar. 12, 2009

(54) Stabilised thermoplastic moulding compounds

(75) Inventors: Martin Stork, Mannheim (DE); Bernd Bruchmann, Freinsheim (DE); Hauke Malz, Diepholz (DE); Michael Breulmann, Bruhl (DE)

Correspondence Address: CONNOLLY BOVE LODGE & HUTZ, LLP, P O BOX 2207, WILMINGTON, DE, 19899, US

(73) Assignee: BASF Aktiengesellschaft Patents, Trademarks and Licenses, Ludwigshafen (DE)

(21) Appl. No.: 11/667,003

(22) PCT Filed: Oct. 28, 2005
(86) PCT No.: PCT/EP05/11590

§ 371 Date: May 2, 2007

(30) Foreign Application Priority Data
Nov. 2, 2004 (DE) 10 2004 052 874.8

(51) Int. Cl. C08L 51/06; C08K 5/36; C08K 5/56

(52) U.S. Cl. 524/301; 525/66; 524/284

(57) ABSTRACT

Thermoplastic molding compositions, processes for making the same and articles made therewith are described wherein the compositions include at least one stabilizer comprising one or more polyisocyanates having an average of 2 to 10 isocyanate groups per molecule, wherein at least one active ingredient group is coupled to the one or more polyisocyanates in an amount of 0.1 to 1.0 mole per mole of isocyanate groups, the at least one active ingredient group selected from phenolic compounds, sterically hindered amines and mixture thereof; and wherein up to 0.9 mole of one or more auxiliary groups is coupled to the one or more polyisocyanates.

The present invention relates to stabilized thermoplastic molding compositions, to stabilizers present therein, and also to processes for preparation of the thermoplastic molding compositions.

There is a wide variety of applications using impact-modified styrene-acrylonitrile polymers, such as ABS (polybutadiene rubber particles grafted with polystyrene-acrylonitrile, in a polystyrene-acrylonitrile matrix) and ASA (polyalkyl acrylate rubber, structure otherwise as ABS). They are preferably used for production of moldings which are intended to have good mechanical properties. A frequent requirement is addition of additives to provide molding compositions with certain properties, examples being antistatic properties, particularly good weathering resistance, etc.

French patent 1 239 902 discloses thermoplastic molding compositions comprising an antistatic agent and EO-PO-EO three-block copolymers (EO=ethylene oxide, PO=propylene oxide).

EP-A 135 801 describes blends composed of polycarbonate, ABS or ASA and of an EO-PO-EO three-block copolymer with certain molar masses of the individual blocks.

EP-A 536 483 discloses ABS molding compositions which comprise a PO polymer whose ends have been capped with EO, and which comprises butylene 1,4-terephthalate units.

U.S. Pat. No. 5,346,959 describes blends composed of ABS, of styrene-maleic anhydride copolymer, and of OH-functionalized PO-EO-PO block copolymers (middle block composed of EO).

DE-A 16 940 101 describes ABS molding compositions stabilized by a phenolic stabilizer, by dilauryl thiodipropionate, and by C₁-C₂₀ fatty acid esters (butyl stearate).

GB patent 1 369 589 discloses styrene-butadiene acrylonitrile copolymers which comprise not only asbestos fibers but also phenolic stabilizers and dilauryl thiodipropionate.

EP-A 184 788 discloses flame-retardant ABS molding compositions which comprise sterically hindered phenols and costabilizers.

WO-A 95/02639 describes stabilization of a recycled styrene-containing plastics material composed of wastes and of collected usable materials. The stabilizers used comprise sterically hindered phenols, metal oxides/hydroxides/carbonates, esters of thiodipropionic acid, and, if appropriate, metal salts of fatty acids.

WO-A 94/07951 discloses the stabilization of plastics composed of waste with a mixture composed of a sterically hindered phenol, an organic phosphite or phosphonite, and metal oxides/hydroxides/carbonates.

EP-A 506 614 describes the stabilization of recycled thermoplastics by sterically hindered phenols and phosphoric esters.

EP-A 669 367 describes ABS molding compositions which have been stabilized with a trialkylphenol, a sterically hindered phenol, and, optionally, dilauryl or distearyl thiodipropionate.

EP-A 712 894 discloses ABS molding compositions and mentions, inter alia, sterically hindered phenols as stabilizers.

DE-A 197 50 747 describes antioxidants of styrene co- and terpolymers such as ABS, composed of a sterically hindered phenol, dilauryl and/or distearyl thiodipropionate, and a phosphite.

WO-A 01/92391 describes stabilized thermoplastic molding compositions comprising, based on components A) to F),

A) from 5 to 70% by weight of at least one graft copolymer A), composed of, based on A),
a1) from 10 to 90% by weight of at least one elastomeric graft base with a glass transition temperature below 0° C., and
a2) from 10 to 90% by weight of at least one graft composed of, based on a2),
   a21) from 50 to 100% by weight of at least one styrene compound,
   a22) from 0 to 50% by weight of acrylonitrile, methacrylonitrile, or a mixture of these,
   a23) from 0 to 50% by weight of at least one other monoethylenically unsaturated monomer,
      B) from 29 to 90% by weight of a hard copolymer composed of, based on B),
b1) from 50 to 100% by weight of at least one styrene compound,
b2) from 0 to 50% by weight of acrylonitrile, methacrylonitrile or a mixture of these,
b3) from 0 to 50% by weight of at least one other monoethylenically unsaturated monomer,
   C) from 0 to 5% by weight of at least one three-block copolymer X-Y-X having a middle block Y composed of propylene oxide units and having terminal blocks X composed of ethylene oxide units,
   D) from 0.01 to 5% by weight of at least one butylated reaction product of p-cresol with dicyclopentadiene of the formula (I)

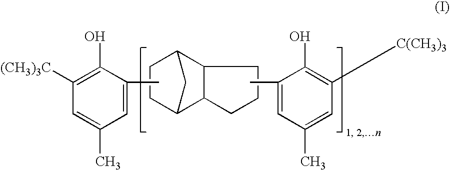

where n≦10,
   E) from 0.01 to 5% by weight of at least one thiocarboxylic ester,
   F) from 0.01 to 5% by weight of at least one alkali metal salt or alkaline earth metal salt of a C₆-C₂₀ carboxylic acid,
   G) from 0 to 30% by weight, based on components A) to G), of other conventional additives,
   where the db* value of the molding compositions after 100 hours of irradiation with light and weathering to ISO 4892/2, Method A, black standard temperature 65° C. is less than +5.0 after weathering, using CIE-Lab color measurement to DIN 6274 and DIN 5033.

A feature common to all of the prior-art molding compositions is that their stabilization with respect to weathering (rain, UV light) and aging in hot conditions (heat-aging) is inadequate or is obtained only at the cost of other advantageous properties, in particular at the cost of good mechanical properties, such as toughness.

Furthermore, the prior-art molding compositions exhibit disadvantageous color deviations. The present invention is therefore intended to provide molding compositions which are in particular uncolored (i.e. do not require addition of colorants to hide the intrinsic color of the molding composition) and have better weathering resistance and heat-aging resistance than the prior-art molding compositions. The thermoplastic molding compositions are at the same time intended to have a balanced profile of mechanical properties, in particular high toughness, even after weathering and heat-aging.

The inventive molding compositions are also intended to ensure that the moldings produced therefrom have a reduced susceptibility to formation of dust marking when the moldings are stored in a dusty atmosphere. The molding compositions should moreover have improved colorant dispersion, i.e. colorants, e.g. pigments, are intended to be capable of particularly uniform dispersion in the molding compositions. Finally, the molding compositions are intended to have better demoldability than prior-art molding compositions during injection molding. One first embodiment achieves these objects via thermoplastic molding compositions comprising, based in each case on components A) and B),
A) from to 5 to 70% by weight, preferably from 8 to 65% by weight, particularly preferably from 10 to 60% by weight, of at least one graft copolymer A), composed of, based in each case on A),
   a1) from 10 to 90% by weight of at least one elastomeric graft base with a glass transition temperature below 0° C.
   a2) from 10 to 90% by weight of at least one graft composed of, based in each case on a2),
      a21) from 50 to 100% by weight of at least one styrene compound,
      a22) from 0 to 50% by weight of acrylonitrile, methacrylonitrile, or a mixture of these,
      a23) from 0 to 50% by weight of at least one other monoethylenically unsaturated monomer,
B) from 30 to 90% by weight, preferably from 34 to 88% by weight, particularly preferably from 39 to 85% by weight, of a hard copolymer composed of, based in each case on B),
   b1) from 50 to 100% by weight of at least one styrene compound,
   b2) from 0 to 50% by weight of acrylonitrile, methacrylonitrile, or a mixture of these,
   b3) from 0 to 50% by weight of at least one other monoethylenically unsaturated monomer.

The first embodiment of the invention thermoplastic molding compositions is one wherein the thermoplastic molding compositions also comprise at least one stabilizer, composed of
(1) one or more polyisocyanates having an average of from 2 to 10, preferably from 2.1 to 10, particularly preferably from 2.2 to 8, isocyanate groups per molecule,
(2) and at least one active ingredient group (2a), (2b), or (2c), having
(2a) from 0.1 to 1.0 mol of one or more active ingredient groups, per mole of isocyanate groups, based on a phenol,
(2b) from 0.1 to 1.0 mol of one or more active ingredient groups, per mole of isocyanate groups, based on sterically hindered amines,
(2c) from 0.1 to 1.0 mol in total of at least two different active ingredient groups, per mole of isocyanate groups, where one active ingredient is based on phenol and the other active ingredient group is based on sterically hindered amines,
   where the active ingredient group(s) protect plastics from damage via heat, UV radiation, oxidation, hydrolysis, or mechanical action during processing, and
(3) per mole of isocyanate groups, from 0 to 0.9 mol of one or more auxiliary groups which modify the properties of the stabilizer, where the auxiliary groups have been coupled to the polyisocyanates by way of a functional group B which can react with the isocyanate groups.

A second embodiment also achieves these objects via thermoplastic molding compositions comprising, based in each case on the entirety of components A), B′), and B″),
A′) from 5 to 70% by weight, preferably from 8 to 65% by weight, particularly preferably from 10 to 60% by weight, of at least one graft copolymer A) composed of, based in each case on A′),
   a1′) from 10 to 90% by weight of at least one elastomeric graft base with a glass transition temperature below 0° C.,
   a2′) from 10 to 90% by weight of at least one graft composed of, based in each case on a2′),
      a21) from 0 to 100% by weight of at least one styrene compound,
      a22) from 0 to 50% by weight of acrylonitrile, methacrylonitrile, or a mixture of these,
      a23) from 0 to 50% by weight of at least one other monoethylenically unsaturated monomer,
      a24) from 0 to 100% by weight of alkyl methacrylate,
B′) from 0 to 65% by weight, preferably from 10 to 50% by weight, particularly preferably from 25 to 45% by weight, of an alkyl methacrylate polymer, obtainable via polymerization of a mixture, composed of, based in each case on B′),
   b1′) from 50 to 100% by weight of alkyl methacrylate,
   b2′) from 0 to 15% by weight of a C₁-C₈-alkyl acrylate,
   b3′) from 0 to 50% by weight of at least one other monoethylenically unsaturated monomer, and
B″) from 0 to 65% by weight, preferably from 10 to 50% by weight, particularly preferably from 25 to 45% by weight, of a copolymer obtainable via polymerization of a mixture, composed of, based in each case on B″),
   b1″) from 50 to 100% by weight of a vinylaromatic monomer,
   b2″) from 0 to 50% by weight of acrylonitrile, methacrylonitrile, or a mixture of these, and
   b3″) from 0 to 50% by weight of at least one other monoethylenically unsaturated monomer.

The second embodiment of the inventive thermoplastic molding compositions is then an embodiment wherein the thermoplastic molding compositions also comprise at least one stabilizer, composed of
(1) one or more polyisocyanates having an average of from 2 to 10, preferably from 2.1 to 10, particularly preferably from 2.2 to 8, isocyanate groups per molecule,
(2) and at least one active ingredient group (2a), (2b), or (2c), having
   (2a) from 0.1 to 1.0 mol of one or more active ingredient groups, per mole of isocyanate groups, based on a phenol,
   (2b) from 0.1 to 1.0 mol of one or more active ingredient groups, per mole of isocyanate groups, based on sterically hindered amines,
   (2c) from 0.1 to 1.0 mol in total of at least two different active ingredient groups, per mole of isocyanate groups, where one active ingredient group is based on phenol and the other active ingredient group is based on sterically hindered amines,
      where the active ingredient group(s) protect plastics from damage via heat, UV radiation, oxidation, hydrolysis, or mechanical action during processing, and
(3) per mole of isocyanate groups, from 0 to 0.9 mol of one or more auxiliary groups which modify the properties of the stabilizer, where the auxiliary groups have been coupled to the polyisocyanates by way of a functional group B which can react with the isocyanate groups.

The embodiments of the present invention differ from one another with regard to components B) and, respectively, B′) and B″), component B) in the first embodiment forming a hard copolymer whereas the hard copolymer in the second embodiment is formed by components B′) and B″).

The following embodiments then relate to the thermoplastic molding compositions of the first and of the second embodiment, unless indicated as particularly applying to only one embodiment.

The inventive thermoplastic molding compositions may comprise conventional additives in the following ranges, based in each case on components A) and B) and, respectively, A′), B′) and B″), and the respective additives. Examples of these are:
C) from 0 to 5% by weight of at least one three-block copolymer X-Y-X having a middle block Y composed of propylene oxide units and having terminal blocks X composed of ethylene oxide units,
D) from 0 to 5% by weight of at least one butylated reaction product of p-cresol with dicyclopentadiene of the formula (I)

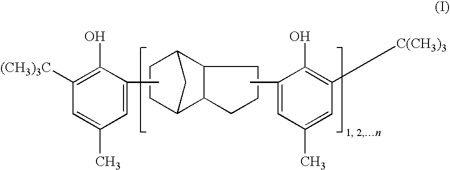

where n≦10,
E) from 0 to 5% by weight of at least one thiocarboxylic ester,
F) from 0 to 5% by weight of at least one alkali metal salt or alkaline earth metal salt of a C₆-C₂₀ carboxylic acid,
G) from 0 to 30% by weight of other conventional additives.

In one preferred embodiment of the inventive molding compositions of the first embodiment, based in each case on components A) to G),
the proportion of component A) is from 5 to 70% by weight, in particular from 8 to 65% by weight, particularly preferably from 10 to 60% by weight,
the proportion of component B) is from 29 to 90% by weight, in particular from 34 to 88% by weight, particularly preferably from 39 to 85% by weight,
the proportion of component C) is from 0 to 5% by weight, in particular from 0.01 to 5% by weight, particularly preferably from 0.01 to 4% by weight, specifically from 0.01 to 3% by weight,
the proportion of component D) is from 0.01 to 5% by weight, in particular from 0.03 to 4% by weight, particularly preferably from 0.05 to 3% by weight,
the proportion of component E) is from 0.01 to 5% by weight, in particular from 0.03 to 4% by weight, particularly preferably from 0.05 to 3% by weight,
the proportion of component F) is from 0.01 to 5% by weight, in particular from 0.02 to 4% by weight, particularly preferably from 0.1 to 3% by weight,
the proportion of component G), based on components A) to G), is 0 to 30% by weight, in particular from 0 to 25% by weight, particularly preferably from 0 to 20% by weight.

In one preferred embodiment of the inventive molding compositions of the second embodiment, based in each case on components A) to G),
the proportion of component A) is from 5 to 70% by weight, in particular from 8 to 65% by weight, particularly preferably from 10 to 60% by weight,
the proportion of component B′) is from 0 to 65% by weight, in particular from 10 to 50% by weight, particularly preferably from 25 to 45% by weight,
the proportion of component B″) is from 0 to 65% by weight, in particular from 10 to 50% by weight, particularly preferably from 25 to 45% by weight,
the proportion of component C) is from 0 to 5% by weight, in particular from 0.01 to 5% by weight, particularly preferably from 0.01 to 4% by weight, specifically from 0.01 to 3% by weight,
the proportion of component D) is from 0.01 to 5% by weight, in particular from 0.03 to 4% by weight, particularly preferably from 0.05 to 3% by weight,
the proportion of component E) is from 0.01 to 5% by weight, in particular from 0.03 to 4% by weight, particularly preferably from 0.05 to 3% by weight,
the proportion of component F) is from 0.01 to 5% by weight, in particular from 0.02 to 4% by weight, particularly preferably from 0.1 to 3% by weight,
the proportion of component G), based on components A) to G), is 0 to 30% by weight, in particular from 0 to 25% by weight, particularly preferably from 0 to 20% by weight.

The total of the weights of all the components in both embodiments gives, of course, 100% by weight.

### Component A) or A′)

Component A) or A′) is a graft copolymer having an elastomeric particulate graft base a1) or a1′) with a glass transition temperature below 0° C., measured by differential scanning calorimetry (DSC) to DIN 53765. The graft base may have been selected from all of the known suitable elastomeric polymers. It is preferably diene rubbers, acrylate rubbers, EPDM rubbers, siloxane rubbers or other rubbers.

The amount present of the graft base in component A) or A′) is from 10 to 90% by weight, preferably from 15 to 85% by weight, particularly preferably from 20 to 80% by weight, based in each case on component A) or A′).

Component a1) or a1′) is preferably at least one (co)polymer composed of, based in each case on a1) or a1′),
a11) from 60 to 100% by weight, particularly preferably from 70 to 100% by weight, of at least one conjugated diene or C₁-C₁₀-alkyl acrylate, or a mixture of these,
a12) from 0 to 35% by weight, particularly preferably from 0 to 30% by weight, of at least one other monoethylenically unsaturated monomer,
a13) from 0 to 10% by weight, particularly preferably from 0 to 5% by weight, of at least one crosslinking monomer.

Monomers which may generally be used as monomers a11) are butadiene, isoprene, chloroprene, or a mixture of these, or else the C₁-C₁₀-alkyl acrylates listed below or a mixture of these. It is preferable to use butadiene or isoprene or a mixture of these, and particular preference is given to the use of butadiene, n-butyl acrylate, 2-ethylhexyl acrylate, or a mixture of these, in particular n-butyl acrylate. Use is especially made of butadiene or n-butyl acrylate.

Component a12) present in component a1) may comprise monomers which vary the mechanical and thermal properties of the graft base within a certain range. Examples which may be mentioned of these monoethylenically unsaturated comonomers are styrene, substituted styrenes, acrylonitrile, methacrylonitrile, acrylic acid, methacrylic acid, dicarboxylic acids, such as maleic acid and fumaric acid, and anhydrides thereof, such as maleic anhydride, nitrogen-functional monomers, such as dimethylaminoethyl acrylate, dimethylaminoethyl acrylate, vinylimidazole, vinylpyrrolidone, vinylcaprolactam, vinylcarbazole, vinylaniline, acrylamide, C₁₋₁₀-alkyl acrylates, such as methyl acrylate, ethyl acrylate, n-propyl acrylate, isopropyl acrylate, n-butyl acrylate, isobutyl acrylate, sec-butyl acrylate, tert-butyl acrylate, ethylhexyl acrylate, the corresponding C₁₋₁₀-alkyl methacrylates, and also hydroxyethyl acrylate, aromatic and araliphatic esters of acrylic acid and methacrylic acid, e.g. phenyl acrylate, phenyl methacrylate, benzyl acrylate, benzyl methacrylate, 2-phenylethyl acrylate, 2-phenylethyl methacrylate, 2-phenoxyethyl acrylate, and 2-phenoxyethyl methacrylate, N-substituted maleimides, such as N-methyl-, N-phenyl-, and N-cyclohexylmaleimide, unsaturated ethers, such as vinyl methyl ether, or a mixture of these.

It is preferable to use styrene, α-methylstyrene, n-butyl acrylate, methyl methacrylate (MMA), or a mixture of these as component a12), in particular styrene and n-butyl acrylate or a mixture of these, especially styrene. If a component a12) is used but no component a13) is used, the proportion of component a11) is preferably from 70 to 99.9% by weight, particularly preferably from 90 to 99% by weight, and the proportion of component a12) is preferably from 0.1 to 30% by weight, particularly preferably from 1 to 10% by weight, based in each case on a1) or a1′). Particular preference is given to butadiene-styrene copolymers and n-butyl acrylate-styrene copolymers in the stated quantity range.

Examples of crosslinking monomers of component a13) are divinyl compounds, such as divinylbenzene, diallyl compounds, such as diallyl maleate, allyl esters of acrylic acid and of methacrylic acid, dihydrodicyclopentadienyl acrylate (DCPA), divinyl esters of dicarboxylic acids, e.g. of succinic acid and adipic acid, diallyl and divinyl ethers of dihydric alcohols, e.g. of ethylene glycol and of 1,4-butanediol.

Component A) or A′) also comprises an amount of from 10 to 90% by weight, preferably from 15 to 85% by weight, particularly preferably from 20 to 80% by weight, based in each case on A) or A′), of a graft.

The graft a2) (first embodiment) is obtained from, based in each case on a2),
a21) from 50 to 100% by weight, particularly preferably from 55 to 90% by weight, in particular from 60 to 85% by weight, of at least one styrene compound,
a22) from 0 to 50% by weight, particularly preferably from 10 to 45% by weight, in particular from 15 to 40% by weight, of acrylonitrile, methacrylonitrile, or a mixture of these,
a23) from 0 to 50% by weight, particularly preferably from 0 to 30% by weight, in particular from 0 to 10% by weight, of at least one other monoethylenically unsaturated monomer.

The graft a2′) (second embodiment) is obtained from, based in each case on a2′),
a21) from 0 to 100%, particularly preferably from 5 to 85% by weight, in particular from 10 to 65% by weight, of at least one styrene compound,
a22) from 0 to 50% by weight, particularly preferably from 0 to 30% by weight, in particular from 0 to 15% by weight, of acrylonitrile, methacrylonitrile, or a mixture of these,
a23) from 0 to 50% by weight, particularly preferably from 0 to 45% by weight, in particular from 0 to 40% by weight, of at least one other monoethylenically unsaturated monomer,
a24) from 0 to 100% by weight, particularly preferably from 5 to 95% by weight, in particular from 10 to 65% by weight, of alkyl methacrylate.

The graft a2) or a2′) comprises at least one styrene compound a21). Preference is given to styrene, α-methylstyrene or other substituted styrenes, and these styrenes may have one or more C₁-C₈-alkyl substituents on the aromatic system. It is particularly preferable to use styrene or α-methylstyrene, or a mixture of these, very particularly preferably styrene.

Other monoethylenically unsaturated monomers a23) which may be used are those mentioned above as monomers a12), preferably methyl methacrylate (MMA) and n-butyl acrylate, particularly preferably methyl methacrylate.

The graft a2) is preferably a styrene-acrylonitrile copolymer, in particular with acrylonitrile content of from 15 to 40% by weight. In one particular, likewise preferred embodiment, the graft a2) comprises from 16 to 30% by weight, preferably from 17 to 28% by weight, particularly preferably from 18 to 25% by weight, of acrylonitrile.

The graft copolymers A) or A′) are usually prepared by the process of emulsion polymerization. For this, the compounds are generally polymerized at a temperature of from 20 to 100° C., preferably from 30 to 80° C. Concomitant use is often made of conventional emulsifiers, such as alkali metal alkyl- or alkylarylsulfonates, alkyl sulfates, sulfonates of fatty alcohols, salts of higher fatty acids having from 10 to 30 carbon atoms, sulfosuccinates, ethersulfonates, or resin soaps. It is preferable to use the alkali metal salts, in particular the sodium or potassium salts of alkylsulfonates or fatty acids having from 10 to 18 carbon atoms. The amounts generally used of the emulsifiers are from 0.2 to 5% by weight, in particular from 0.3 to 3% by weight, based on the monomers used in preparation of the graft base.

The amount of water preferably used to prepare the dispersion is that which gives the finished dispersion a solids content of from 20 to 55% by weight. Operations are usually carried out with a water/monomer ratio of from 2:1 to 0.7:1.

Suitable free-radical generators for initiating the polymerization reaction are those which decompose at the selected reaction temperature, i.e. those which decompose thermally by themselves and those which do so in the presence of a redox system. Examples of preferred polymerization initiators are free-radical generators such as peroxides, preferably peroxosulfates (such as sodium persulfate or potassium persulfate) and azo compounds, such as azodiisobutyronitrile. However, it is also possible to use redox systems, especially those based on hydroperoxides, such as cumene hydroperoxide. The polymerization initiators are generally used in amounts of from 0.1 to 1% by weight, based on the graft base monomers.

The free-radical generators and the emulsifiers are added to the reaction mixture, for example by adding the total amount batchwise at the beginning of the reaction, or by batchwise addition, divided into a number of portions, at the beginning and at one or more later times, or continuously over a defined period. Continuous addition may also follow a gradient which may, for example, rise or fall and be linear or exponential or else follow a step function.

Concomitant use may also be made of molecular weight regulators, such as ethylhexyl thioglycolate, n- or tert-dodecyl mercaptan, or other mercaptans, terpinols, or dimeric methylstyrene, or other compounds suitable for regulating molecular weight. The molecular weight regulators are added to the reaction mixture batchwise or continuously, as described above for the free-radical generators and emulsifiers.

To maintain constant pH, preferably from 6 to 9, concomitant use may be made of buffer substances, such as sodium pyrophosphate, Na₂HPO₄/NaH₂PO₄, sodium hydrogencarbonate, or buffers based on citric acid/citrate. The amounts used of molecular weight regulators and buffer substances are those which are usual, and it is therefore unnecessary to give further details in this connection.

It can also be advantageous to use other electrolytes (in particular salts) to adjust the particles sizes and their distribution.

In one particular embodiment, the graft base may also be prepared by polymerizing the monomers a1) or a1′) in the presence of a finely divided latex (using the seed-latex polymerization procedure). This latex forms an initial charge and may be composed of monomers forming elastomeric polymers, or else of the other monomers mentioned above. Examples of suitable seed latices are those composed of polybutadiene or of polystyrene.

In another preferred embodiment, the graft base a1) or a1′) may be prepared by what is known as the feed process. In this process, a certain proportion of the monomers forms an initial charge, the polymerization is then initiated, and the remainder of the monomers (“feed”) a1) or a1′) is then added as a feed during the course of the polymerization. The feed parameters (gradient shape, amount, duration, etc.) depend on the other conditions of the polymerization. The principles of the descriptions given in connection with the method of addition of the free-radical initiator and/or emulsifier are once again relevant here.

Graft polymers having a number of “soft” and “hard” shells are also suitable.

The precise polymerization conditions, in particular the type, amount, and method of addition of the emulsifier, and of the other polymerization auxiliaries, are preferably selected so that the resultant latex of the graft polymer a1) or a1′) has a median particle size, defined by the d50 of the particle size distribution, of from 80 to 800 nm, preferably from 80 to 500 nm, and particularly preferably from 85 to 400 nm.

In one embodiment of the invention, the reaction conditions are balanced in such a way as to give the polymer particles a bimodal or polymodal particle size distribution, i.e. a size distribution with at least two fairly well-developed maxima.

The bimodal particle size distribution is preferably achieved by (partial) agglomeration of the polymer particles. One way of achieving this is the following procedure: the monomers which form the core are polymerized to a conversion which is usually at least 90%, preferably greater than 95%, based in each case on the monomers used. This conversion is generally achieved in from 4 to 20 hours. The resultant rubber latex has an average particle size d50 of not more than 200 nm, and a narrow particle size distribution (an almost monodisperse system).

In the second stage, the rubber latex is agglomerated. This is generally done by adding a dispersion of an acrylate polymer. Preference is given to dispersions of copolymers of C₁-C₄-alkyl acrylates, preferably of ethyl acrylate, with from 0.1 to 10% by weight of monomers which form polar polymers, examples being acrylic acid, methacrylic acid, acrylamide, methacrylamide, N-methylolmethacrylamide, and N-vinylpyrrolidone. Particular preference is given to a copolymer composed of from 90 to 96% of ethyl acrylate and from 4 to 10% of methacrylamide. The agglomerating dispersion may, where appropriate, also comprise more than one of the acrylate polymers mentioned.

The concentration of the acrylate polymers in the dispersion used for agglomeration should generally be from 3 to 40% by weight. The agglomeration process uses from 0.2 to 20% by weight, preferably from 1 to 5% by weight, of the agglomerating dispersion for each 100 parts of the rubber latex, the calculation in each case being based on solids. The agglomeration is carried out by adding the agglomerating dispersion to the rubber. The addition usually takes from about 1 to 30 minutes at from 20 to 90° C., preferably from 30 to 75° C.

Besides an acrylate polymer dispersion, use may also be made of other agglomerating agents, such as acetic anhydride, for agglomerating the rubber latex. Agglomeration by pressure or by freezing (pressure agglomeration or freeze agglomeration) is also possible. The methods mentioned are known to the skilled worker.

Under the conditions mentioned, the rubber particles are only partially agglomerated, giving a bimodal distribution. More than 50%, preferably from 60 to 95%, of the particles (distribution by number) are generally in the non-agglomerated state after the agglomeration. The resultant partially agglomerated rubber latex is relatively stable, and it is therefore easy to store and transport without coagulation.

Another way of achieving bimodal particle size distribution of the graft polymer A) or A′) is to prepare, separately from one another and in the usual manner, two different graft polymers AA) and AB) which differ in their average particle size, and to mix the graft polymers AA) and AB) in the desired quantitative proportion.

The conditions for preparing the graft a2) or a2′) may be the same as those used for preparing the graft base a1) or a1′), and the graft a2) or a2′) may be prepared in one or more process steps. In two-step grafting, for example, it is possible first of all to polymerize styrene and/or α-methylstyrene alone, and then styrene and acrylonitrile, in two sequential steps. This two-step grafting (firstly styrene, then styrene/acrylonitrile) is a preferred embodiment.

Further details concerning the preparation of the graft polymers A1) or A1′) are given in DE-A 12 60 135 and DE-A 31 49 358, and also EP-A 735 063 which is incorporated into the present invention by way of reference.

It is advantageous for the graft polymerization onto the graft base a1) or a1′) also to be carried out in aqueous emulsion. It may be undertaken in the same system as used for polymerizing the graft base, in which case further emulsifier and initiator may be added. These do not have to be identical with the emulsifiers or initiators used for preparing the graft base a1) or a1′). For example, it may be advantageous to use a persulfate as initiator for preparing the graft base a1) or a1′), but a redox initiator system for polymerizing the graft shell a2) or a2′). In other respects, that which has been said concerning the graft base a1) or a1′) is applicable to the selection of emulsifier, initiator, and polymerization auxiliaries. The monomer mixture to be grafted on may be added to the reaction mixture all at once, in portions in more than one step or, preferably, continuously for a specified time interval during the polymerization.

If ungrafted polymers made from the monomers a) or a2′) are produced during the grafting of the graft base a1) or a1′), the amounts of these, generally below 10% by weight of a2) or a2′), are counted with the weight of component A) or A′).

### Component B)

Component B) is a hard copolymer composed of, based on B),
b1) from 50 to 100% by weight, particularly preferably from 55 to 90% by weight, in particular from 60 to 85% by weight, of at least styrene compound,
b2) from 0 to 50% by weight, particularly preferably from 10 to 45% by weight, in particular from 15 to 40% by weight, of acrylonitrile or methacrylonitrile or a mixture of these,
b3) from 0 to 50% by weight, particularly preferably from 0 to 30% by weight, in particular 0 from 20% by weight, of at least one other monoethylenically unsaturated monomer.

The viscosity number VN of component B) (determined to DIN 53726 at 25° C., 0.5% strength by weight in dimethylformamide) is preferably from 50 to 120 ml/g, particularly preferably from 52 to 110 ml/g, in particular from 55 to 105 ml/g.

The styrene compound b1) used may comprise the monomers mentioned for a21), in particular styrene, α-methylstyrene or a mixture of these. The proportion of α-methylstyrene in this type of mixture is preferably 50% by weight, based on b1). It is particularly preferable to use styrene alone.

Other monoethylenically unsaturated monomers b3) which may be used comprise the abovementioned monomers for a12), in particular MMA, and also N-alkyl- and N-arylmaleimides, such as N-phenylmaleimide.

B) is preferably a styrene-acrylonitrile copolymer. It is particularly preferable to use a styrene-acrylonitrile copolymer having from 15 to 40% by weight, in particular from 20 to 33% by weight, of acrylonitrile as component b2). The copolymer preferably comprises from 22 to 31% by weight, particularly preferably from 23 to 29% by weight, of acrylonitrile.

Copolymers of this type are obtained in a known manner via bulk, solution, suspension, precipitation, or emulsion polymerization, preference being given to bulk and solution polymerization. Details of these processes are described, by way of example, in Kunststoffhandbuch [Plastics Handbook], edited by R. Vieweg and G. Daumiller, Volume V “Polystyrol” [Polystyrene], Carl-Hanser-Verlag Munich 1969, page 118 et seq.

Preference is given to thermoplastic molding compositions in which compound a11) is butadiene and component B) is a styrene-acrylonitrile copolymer having from 10 to 50% by weight, particularly preferably from 22 to 33% by weight, in particular from 23 to 29% by weight, of acrylonitrile.

### Component B′)

The alkyl methacrylate polymers (B′) used in the inventive thermoplastic molding compositions are either homopolymers composed of alkyl methacrylate or copolymers composed of alkyl methacrylate with up to 15% by weight, based on (B′), of a C₁-C₈-alkyl acrylate. A particularly preferred alkyl methacrylate is methyl methacrylate (MMA).

C₁-C₈-alkyl acrylates (component b2′)) which may be used are methyl acrylate, ethyl acrylate, propyl acrylate, n-butyl acrylate, n-pentyl acrylate, n-hexyl acrylate, n-heptyl acrylate, n-octyl acrylate and 2-ethylhexyl acrylate, or a mixture of these, preferably methyl acrylate, ethyl acrylate, n-butyl acrylate, 2-ethylhexyl acrylate, or a mixture of these, particularly preferably methyl acrylate.

The methyl methacrylate (MMA) polymers may be prepared via bulk, solution, or suspension polymerization by known methods (see, for example, Kunststoff-Handbuch [Plastics Handbook], Volume IX, “Polymethacrylate” [Polymethacrylates], Vieweg/Esser, Carl-Hanser-Verlag 1975), and are commercially available. It is preferable to use methyl methacrylate polymers whose weight-average value M_{W} for molar mass is in the range from 60 000 to 300 000 g/mol (determined via light scattering in chloroform).

Components B′) may also comprise from 0 to 50% by weight of at least one other monoethylenically unsaturated monomer, such as acrylonitrile, methacrylonitrile, styrene, α-methylstyrene, or a mixture of these.

### Component B″)

Component (B″) is a copolymer composed of a vinylaromatic monomer (b1″), of a vinyl cyanide (acrylonitrile, methacrylonitrile, or a mixture of these), and of at least one other monoethylenically unsaturated monomer, in the ranges of amounts stated above.

The vinylaromatic monomers (component b1″)) used may comprise styrene, styrene substituted by from one to three C₁-C₈-alkyl radicals, e.g. p-methylstyrene or tert-butylstyrene, or else α-methylstyrene, but preferably styrene.

The vinyl cyanide (component b2″) used may comprise acrylonitrile and/or methacrylonitrile, preferably acrylonitrile.

The monoethylenically unsaturated monomers b3″) used may comprise the monomers mentioned above for a12), in particular MMA, and also N-alkyl- and N-arylmaleimides, such as N-phenylmaleimide.

Outside the range given above for the formulation of component (B″), processing temperatures above 240° C. usually give cloudy molding compositions which have streaks.

The copolymers (B″) may be prepared by known processes, such as bulk, solution, suspension, or emulsion polymerization, preferably via solution polymerization (see GB-A 14 72 195). Preference is given here to copolymers (B″) with molar masses M_{W} of from 60 000 to 300 000 g/mol, determined via light scattering in dimethylformamide.

### Component C)

This component is preferably an EO-PO-EO three-block copolymer (EO=ethylene oxide, PO=propylene oxide). The average molecular weight Mn of the PO middle block is preferably from 2000 to 4000, particularly preferably from 2200 to 3800, in particular from 2300 to 3500, very particularly preferably about 2300, about 2750, or about 3250, in each case ±10%. The average proportion of the terminal EO blocks taken together is preferably from 3 to 28% by weight, particularly preferably from 8 to 24% by weight, in particular from about 8 to 14 or from 18 to 24% by weight, based in each case on C).

The three-block copolymers used of the formula X-Y-X may be prepared in a manner known per se (N. Schönfeldt, Grenzflächenaktive Ethylenoxid-Addukte [Interfacially active ethylene oxide adducts], Wissenschaftliche Verlagsgesellschaft mbH Stuttgart, 1976, pp. 53 et seq.), via polymerization where a middle polypropylene oxide block Y is first prepared and a block X composed of ethylene oxide units is added to each of its ends. The molecular weights given above are generally average molecular weights (number average Mₙ, for example determined from the OH number to DIN 53240).

Preferred three-block copolymers and their preparation are also described in EP-A 125 801 and EP-A 018 591.

An example of component C) is Pluronic® (BASF), which is available commercially.

### Component D)

This component is a butylated reaction product of cresole with dicyclopentadiene of the formula (II)

(n≦10, preferably ≦6)

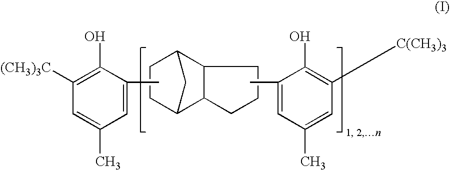

It is preferable to use the isomer of the formula (II)

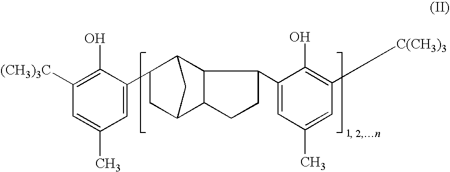

with average molecular weight of from 600 to 700.

It is available commercially, e.g. in the form of Santowhite®ML (Monsanto), Lowinox®22 CP46, or LOWINOX®CPL (Lowi/Great Lakes), Wingstay®L (Goodyear), or Ralox®LC (Raschig).

### Component E)

This component is a thiocarboxylic ester. Preference is given to C₆-C₂₀ fatty alkohol esters of thiopropionic acid, particularly the stearyl ester and the lauryl ester. It is particularly preferable to use dilauryl thiodipropionate, or distearyl thiodipropionate, or a mixture of these.

Dilauryl thiodipropionate is available, by way of example, in the form of Cyanox®LTDP (American Cyanamid), Hostanox®SE1 or SE3 (Clariant); Irganox®PS 800 (Ciba-Geigy), Lowinox®DLTDP (Lowi), or Sumilizer®TPLR (Sumitomo). Distearyl thiodipropionate is available, by way of example, in the form of Cyanox®STDP (American Cyanamid), Hostanox®SE2 or SE4 (Clariant), Irganox®PS 802 (Ciby-Geigy), Lowinox®DSTDP (Lowi), and Sumilizer®TPS (Sumitomo). The other suitable sulfur-containing carboxylic esters are also known and commercially available.

### Component F)

This component is an alkali metal salt or alkaline earth metal salt of a C₆-C₂₀ carboxylic acid. Preference is given to the salts of sodium and of potassium, and also of magnesium, or calcium, and of zinc. Preferred carboxylic esters are those of stearic acid, lauric acid, oleic acid, and palmitic acid. It is particularly preferable to use calcium stearate, zinc stearate, magnesium stearate, potassium stearate, or sodium stearate, especially magnesium stearate or potassium stearate.

These substances are known and are available in the chemicals market.

In the case of all of the additives C) to F), it is also, of course, possible to use a mixture of different additives C′), C″) . . . to F′), F″) . . . , which comply with the definition of the respective additive.

### Component G)

The inventive thermoplastic molding compositions may also comprise other additives, as component G). Examples of these are auxiliaries and fillers. Examples of substances of this type are lubricants or mold-release agents, waxes, pigments, dyes, flame retardants, fibrous and pulverulent fillers or fibrous and pulverulent reinforcing agents, and also other additives, or a mixture of these.

Examples of suitable lubricants and mold-release agents are stearic acids, stearyl alcohol, stearic esters, stearinamides, and also silicone oils, montan waxes, and those based on polyethylene and polypropylene.

Examples of pigments are titanium dioxide, phthalocyanines, ultramarine blue, iron oxides, or carbon black, and also the entire class of organic pigments.

Dyes are any of the dyes which can be used for the transparent, semitransparent, or non-transparent coloring of polymers, in particular those suitable for coloring of styrene copolymers. Dyes of this type are known to the person skilled in the art.

Examples of flame retardants which may be used are the halogen-containing or phosphorus-containing compounds known to the person skilled in the art, magnesium hydroxide, and also other commonly used compounds or a mixture of these. Red phosphorus is also suitable.

Examples which may be mentioned of fibrous or pulverulent fillers are carbon fibers or glass fibers in the form of glass textiles, glass mats, or glass silk rovings, chopped glass, glass beads, and also wollastonite, particularly preferably glass fibers. If glass fibers are used, these may have been equipped with a size and a coupling agent to improve compatibility with the components of the blend. The glass fibers incorporated may either be short glass fibers or else continuous-filament strands (rovings).

Suitable particulate fillers are carbon black, amorphous silica, magnesium carbonate, (chalk), powdered quartz, mica, bentonites, talc, feldspar, or in particular calcium silicates, such as wollastonite, and kaolin.

The amounts used of each of the fillers are the conventional amounts, and further details in this connection would therefore be superfluous.

### Stabilizers

The inventive thermoplastic molding compositions also comprise stabilizers based on polyisocyanates.

It is known that plastics can be protected from damaging environmental effects via addition of stabilizers. By way of example, plastics may be protected from UV damage via a mixture composed of an antioxidant (AO) and of a hindered amine light stabilizer (HALS), or via a mixture composed of a UV absorber and of a phenolic antioxidant, or via a mixture composed of a phenolic antioxidant, of a HALS, and of a UV absorber. A method which has mostly proven successful for protection from damage via thermal stress is addition of antioxidants, such as sterically hindered phenols, aromatic amines, and phosphates, or thiosynergists.

The stabilizers used in the inventive thermoplastic molding compositions are composed of
(1) one or more polyisocyanates having an average of from 2 to 10, preferably from 2.1 to 10, particularly preferably from 2.2 to 8, isocyanate groups per molecule,
(3) per mole of isocyanate groups, from 0 to 0.9 mol of one or more auxiliary groups which modify the properties of the stabilizer, where the auxiliary groups have been coupled to the polyisocyanates by way of functional groups B which can react with the isocyanate groups.

In a first variant, the stabilizers used according to the invention also comprise
(2a) from 0.1 to 1.0 mol of one or more active ingredient groups, per mole of isocyanate groups, based on a phenol, which protect from damage via heat, UV radiation, oxidation, hydrolysis, or mechanical effects during processing.

In a second variant, the stabilizers used according to the invention also comprise
(2b) from 0.1 to 1.0 mol of one or more active ingredient groups, per mole of isocyanate groups, based on sterically hindered amines, which protect plastics from damage via heat, UV radiation, oxidation, hydrolysis, or mechanical effects during processing.

In a third variant, the stabilizers used according to the invention also comprise
(2c) from 0.1 to 1.0 mol in total of at least two different active ingredient groups, per mole of isocyanate groups, one active ingredient group being based on phenol and the other active ingredient group being based on sterically hindered amine, the active ingredient groups being those which protect plastics from damage via heat, UV radiation, oxidation, hydrolysis, or mechanical effects during processing.

The inventive stabilizers may comprise, in bonded form, precisely one active ingredient group or two or more different active ingredient groups, for example two or more different sterically hindered phenols, two or more different HALS compounds, or one or more sterically hindered phenols and one or more HALS compounds.

Examples of the properties of the stabilizers modified via the auxiliary groups are emulsifiability or solubility in polar or non-polar solvents and/or capability for incorporation into a plastic or a plastics mixture.

### Polyisocyanates

The polyisocyanates (1) comprise an average of from 2 to 10, preferably from 2.1 to 10, particularly preferably from 2.2 to 8, isocyanate groups per molecule.

Di- and polyisocyanates which may be used are the prior-art aliphatic, cycloaliphatic, and aromatic isocyanates. Preferred di- or polyisocyanates are diphenylmethane 4,4′-diisocyanate, diphenylmethane 2,4′-diisocyanate, the mixtures composed of monomeric diphenylmethane diisocyanates and of oligomeric diphenylmethane diisocyanates (polymeric MDI), tolylene 2,4-diisocyanate, tolylene 2,6-diisocyanate, naphthylene 1,5- and 2,6-diisocyanate, phenylene 1,3- and 1,4-diisocyanate, diphenyl diisocyanate, toluidine diisocyanate, triisocyanatotoluene, tetramethylene diisocyanate, hexamethylene diisocyanate, isophorone diisocyanate, methylenebis(cyclohexyl) 2,4′- or 4,4′-diisocyanate, o-, m-, or p-xylylene diisocyanate, tetramethylxylylene diisocyanate, dodecyl diisocyanate, lysine alkyl ester diisocyanate, where alkyl is C₁-C₁₀-alkyl, 2,2,4- or 2,4,4-trimethylhexamethylene 1,6-diisocyanate, 1,4-diisocyanatocyclohexane, 4-isocyanatomethyloctamethylene 1,8-diisocyanate, 2-butyl-2-ethylpentamethylene diisocyanate, 2-isocyanatopropylcyclohexyl isocyanate, 3(4)-isocyanatomethyl-1-methylcyclohexyl isocyanate, 1,3- or 1,4-bis(isocyanatomethyl)cyclohexane, 1,4-diisocyanato-4-methylpentane, and 4-methylcyclohexane 1,3-diisocyanate (H-TDI).

It is preferable to use mixtures composed of two or more of the above-mentioned polyisocyanates.

Other suitable polyisocyanates are compounds which can be prepared from the abovementioned di- or polyisocyanates or their mixtures via linking by means of urethane, allophanate, urea, biuret, uretdione, amide, isocyanurate, carbodiimide, uretonimine, oxadiazinetrione, or iminooxadiazinedione structures. By way of example, these linking mechanisms are described in Becker and Braun, Kunststoff-Handbuch Nr. 7 [Plastics Handbook No. 7], Polyurethane [Polyurethanes], Carl-Hanser-Verlag Munich 1993. It is preferable to use polyisocyanates which contain urethane structures, allophanate structures, urea structures, biuret structures, isocyanurate structures, uretonimine structures, oxadiazinetrione structures, or iminoxadiazinedione structures.

It is also possible to use a mixture of the abovementioned polyisocyanates.

The linkage of the di- or polyisocyanates by way of urethane groups preferably takes place with use of alcohols or alcohol mixtures whose functionality is 2 or greater. By way of example, mention may be made of the reaction of 3 mol of hexamethylene diisocyanate, isophorone diisocyanate, tolylene diisocyanate, or diphenylmethylene diisocyanate with ≦1 mol of triol, such as glycerol or trimethylolpropane, or else the reaction of two mol of an oligomeric diphenylmethane diisocyanate (polymeric MDI) with ≦1 mol of diol, such as ethylene glycol, butanediol, hexanediol, or with a polyoxyalkylenediol. These reactions form branched polyisocyanates whose functionality is greater than 2. In this connection see also Becker and Braun, Kunststoff-Handbuch Nr. 7 [Plastics Handbook No. 7], Polyurethane [Polyurethanes], Carl-Hanser-Verlag Munich 1993, page 91.

Polyisocyanates comprising allophanate groups are produced from polyisocyanates comprising urethane groups by reacting the urethane groups with further isocyanate groups. In this connection, see also Becker and Braun, Kunststoff-Handbuch Nr. 7 [Plastics Handbook No. 7], Polyurethane [Polyurethanes], Carl-Hanser-Verlag Munich 1993, page 94. Another preparation route is the reaction of oxadiazinetriones with alcohols according to EP 825211. By way of example for the preparation of an allophanate, mention may be made of the reaction of hexamethylene diisocyanate or isophorone diisocyanate with monoalcohols, which according to GB 994 890, EP 496 208, EP 524 500, or EP 524 501 give oligoisocyanates whose functionality is greater than 2. Mention may also be made of the reaction of hexamethylene diisocyanate or isophorone diisocyanate with di- or polyhydric alcohols, as described by way of example in EP 1122273. These reactions form branched polyisocyanates having functionality greater than 2.

By way of example, polyisocyanates comprising urea groups and comprising biuret groups may be prepared via reactions of isocyanates with water or with amines. In this connection see also Becker and Braun, Kunststoff-Handbuch Nr. 7 [Plastics Handbook No. 7], Polyurethane [Polyurethanes], Carl-Hanser-Verlag Munich 1993, page 95. By way of example, mention may be made of the reaction of hexamethylene diisocyanate or isophorone diisocyanate with water or with water-generating substances, as are described in DE-A 28 08 801, DE-A 34 03 277, or DE-A 15 43 178. These reactions form branched polyisocyanates having functionality greater than 2.

Polyisocyanates comprising isocyanurate structures are obtained by catalytic or thermal cyclization of three isocyanate groups. If di- or polyisocyanates are used as starting compounds, the products are generally not only the actual trimers but also higher oligomeric polyisocyanates. The overall functionality of these polyisocyanates is therefore greater than 3. In this connection see also Becker and Braun, Kunststoff-Handbuch Nr. 7 [Plastics Handbook No. 7], Polyurethane [Polyurethanes], Carl-Hanser-Verlag Munich 1993, page 91. By way of example, mention may be made of the preparation of branched polyisocyanates via isocyanuratization of hexamethylene diisocyanate or of isophorone diisocyanate, a possible method for which is that according to DE-A 29 16 201 or DE-A 38 10 908.

Polyisocyanates comprising uretonimine groups are obtained via further reaction of isocyanate groups with polyisocyanates comprising carbodiimide groups. In this connection see also Becker and Braun, Kunststoff-Handbuch Nr. 7 [Plastics Handbook No. 7], Polyurethane [Polyurethanes], Carl-Hanser-Verlag Munich 1993, page 94.

Polyisocyanates comprising oxadiazinetrione groups are obtained via reaction of di- or polyisocyanates with carbon dioxide, e.g. as described in DE-A 16 70 666.

Polyisocyanates comprising iminooxadiazinedione groups can be regarded as asymmetric relatives of the polyisocyanates comprising isocyanurate groups. The preparation of these compounds is described by way of example in DE-A 197 34 048.

In one preferred embodiment of the invention, use is made of aliphatic or cycloaliphatic branched di- or polyisocyanates.

### Active Ingredient Groups

The inventive stabilizers comprise one or more active ingredient groups (2=2a, 2b, 2c), these active ingredient groups having been coupled to the polyisocyanates by way of functional groups A active with respect to the NCO groups of the polyisocyanates.

For the purposes of the present invention, active ingredient groups (2) are groups which protect a plastic or a plastics mixture from damaging environmental effects.

Examples are primary and secondary antioxidants, hindered amine light stabilizers, UV absorbers, hydrolysis stabilizers, quenchers, and flame retardants.

In principle, an inventive stabilizer may contain one or more active ingredient groups, which may also be different. The number of the active ingredient groups here is variable, as is the ratio of each of the active ingredient groups to the others, the only restrictions on these factors being the result of the number of NCO groups in the polyisocyanates (1). However, it is not necessary here that every NCO group in the polyisocyanates (1) has been reacted with an active ingredient group.

If the intention is that an inventive stabilizer act as, by way of example, antioxidant, the active ingredient groups (2) which are coupled to the NCO groups of the polyisocyanates (1) may be those which slow or prevent oxidative degradation of a plastic.

One class of active ingredient groups (2) which act as antioxidants is that of sterically hindered phenols.

In one embodiment of the invention, the inventive stabilizers therefore comprise, as active ingredient group (2a), a sterically hindered phenol of the general formula (III)

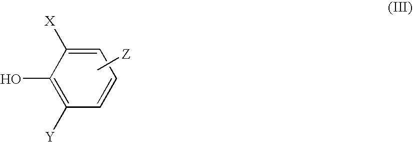

in bonded form.

Here, each of X and Y is, independently of the other, a hydrogen atom or a straight-chain, branched, or cyclic alkyl radical having from 1 to 12 carbon atoms, and Z is a radical of the formula

—C—R¹-A

where R¹ is a single bond or a linear or branched divalent organic radical having from 1 to 100 carbon atoms, preferably from 1 to 12 carbon atoms, particularly preferably from 1 to 6 carbon atoms, or R¹ is a divalent radical of the formula

—(R²C¹—R³)ₘ—

where each of R² and R³ is identical with or different from the other and, independently of the other, is a single bond, a linear or branched divalent organic radical having from 1 to 50 carbon atoms, preferably from 1 to 10 carbon atoms, in particular from 1 to 4 carbon atoms and m is a number from 1 to 100, preferably from 1 to 10, and particularly preferably from 1 to 4.

Each of C and C¹ is, independently of the other, a single bond, an oxygen atom, a sulfur atom, an —NH— or —NR— group, an ester group (—C(O)O— or —O(O)C—), an amide group (—NHC(O)— or —C(O)NH—), a urethane group (—OC(O)NH— or —HNC(O)O—), or a urea group (—HNC(O)N— or —NC(O)NH—).

“Independently of one another” means that R² and, respectively, R³ may be a different radical in each of the m repeat units corresponding to C¹.

A is a functional group which bonds the active ingredient group to the anchor group. Examples of A are primary or secondary amino groups, hydroxy groups, thiol groups, carboxy groups, or epoxy groups. Preferred functional groups A are hydroxy groups, thiol groups, and primary or secondary amino groups.

The stabilizers preferably comprise, as phenolic active ingredient group (2a), a sterically hindered phenol of the formula (IV) in bonded form,

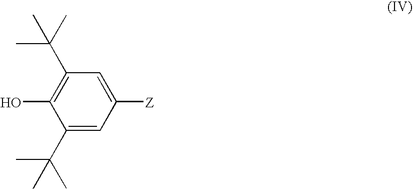

where z is as defined above.

Examples of preferred groups Z are

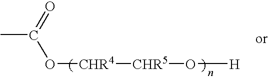

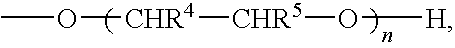

where R⁴ and R⁵, independently of one another, are hydrogen, linear or branched alkyl chains having from 1 to 10 carbon atoms, preferably 1 to 4 carbon atoms. Groups Z of this type are obtained by using an oligo- or polyalkylene oxide diol to esterify a sterically hindered phenol comprising carboxylic acid groups, or using ethylene oxide, propylene oxide, butylene oxide, or a mixture of these to alkoxylate a sterically hindered phenol having OH groups.

Another group of active ingredients (2b) which stabilizes polymers with respect to the effect of UV light is that known as hindered amine (light) stabilizers (HAS or HALS, sterically hindered amines). The activity of the HALS compounds is based on their ability to form nitroxyl radicals, which intervene in the mechanism of oxidation of polymers. HALS are highly efficient UV stabilizers for most polymers.

In another embodiment, the inventive stabilizers therefore comprise, as active ingredient group (2b), a sterically hindered amine in bonded form, capable of forming nitroxyl radicals.

In one preferred embodiment of the invention, the inventive stabilizers comprise, as active ingredient groups (2b), active HALS ingredients of the general formula (V) in bonded form,

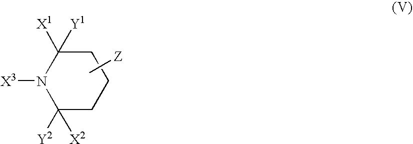

where X¹, X², Y¹, Y², and X³, independently of one another, are a hydrogen atom, a straight-chain or branched alkyl radical, or a cycloalkyl radical having from 1 to 12 carbon atoms, and X³ may moreover be an acyl radical having from 2 to 18 carbon atoms, an alkoxy radical having from 1 to 19 carbon atoms, or an aryloxycarbonyl radical having from 7 to 12 carbon atoms, Z being defined as above.

Another active ingredient group (2b) is that of aromatic amines. Aromatic amines here are any of the compounds which have a substituted or unsubstituted amino group bonded directly to an aromatic system. Depending on substitution, aromatic amines serve as antioxidants or else as active ingredient with respect to the damaging effect of ozone.

In another embodiment of the invention, the inventive stabilizers comprise, as active ingredient group (2b), aromatic amines of the general formula (VI) in bonded form,

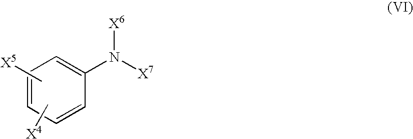

where X⁴, X⁵, X⁶, and X⁷, independently of one another, are a hydrogen atom, a straight-chain or branched alkyl radical, or a cycloalkyl radical having from 1 to 12 carbon atoms, or Z, Z being defined as above, and
X⁷ may moreover be

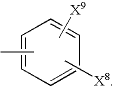

X⁸ and X⁹ are, independently of one another, a hydrogen atom, a straight-chain or branched alkyl radical, or a cycloalkyl radical having from 1 to 12 carbon atoms, or Z, Z being defined as above.

In another embodiment, the stabilizers comprise two different active ingredient groups (2c), one active ingredient group being based on phenol (2a; see above) and the other being based on sterically hindered amine (2b; see above).

The stabilizers may moreover comprise other active ingredient groups:
Another suitable class of active ingredients is that phosphorus compounds, e.g. used as secondary antioxidant. In another embodiment of the invention, the inventive stabilizers comprise, as active ingredient groups, groups which comprise trivalent phosphorus in bonded form, for example groups which derive from organophosphorus compounds of trivalent phosphorus, e.g. phosphites and phosphonites. In one preferred embodiment of the invention, the inventive stabilizers comprise an active phosphorus ingredient of the general formula (VII)

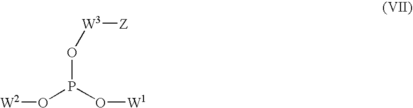

in bonded form, where W¹, W², and W³ are, independently of one another, a straight-chain, branched or cyclic alkyl radical having from 1 to 30 carbon atoms, or a substituted or unsubstituted aryl radical having from 3 to 30 carbon atoms. W² and W³ may also, independently of each other, be hydrogen, and Z is as defined above.
An example of an active phosphorus ingredient is the following compound of the formula (VIII)

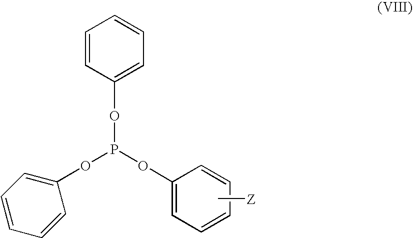

Another class of active ingredients which protect polymers from oxidative degradation is that of thio compounds. Thio compounds comprise at least one sulfur atom. If there are two or more sulfur atoms present in the thio compound, these may have direct bonding to one another or have separation from one another via an organic radical. Preference is given to thio compounds in which the sulfur atoms do not have direct bonding to one another. Thio compounds which according to the invention can be used in the structure of the stabilizers comprise a functional group D which can react with the functional groups B of the anchor group. Suitable functional groups are substituted and unsubstituted amino, hydroxy, thiol, carboxy, isocyanato and epoxy groups, and activated double bonds. Preference is given to hydroxy groups and substituted and unsubstituted amino groups.
In another embodiment of the invention, the stabilizers therefore also comprise, as active ingredient group, active thio ingredients of the general formula (IX)

R⁶—S—R⁷-Z (IX)
in bonded form. In these, R⁶ is a linear or branched aliphatic organic radical comprising from 1 to 100 carbon atoms, preferably from 1 to 12 carbon atoms, in particular from 1 to 6 carbon atoms, R⁷ is a single bond or a divalent linear or branched aliphatic or aromatic radical having from 1 to 100 carbon atoms, preferably from 1 to 12 carbon atoms, in particular from 1 to 6 carbon atoms, and Z is as defined above.
For protection from UV degradation, UV absorbers may be bonded as active ingredient group to the hyperbranched anchor group. Suitable UV absorbers are those compounds which absorb in the UV-A and UV-B region of the spectrum.
In another embodiment of the invention, the active ingredient groups which act as UV absorbers are diphenylcyanoacrylates, benzotriazoles, benzophenones, cinnamic esters, benzylidenemalonates, and diarylbutadienes. The UV absorbers mentioned comprise functional groups D which react with the functional groups B of the anchor group. Functional groups of this type are substituted and unsubstituted amino, hydroxy, thiol, carboxy, isocyanato, and epoxy groups, and activated double bonds. Preference is given to hydroxy groups and substituted and unsubstituted amino groups.
Examples are stabilizers which comprise an active ingredient group of the formulae (X) to (XIII)

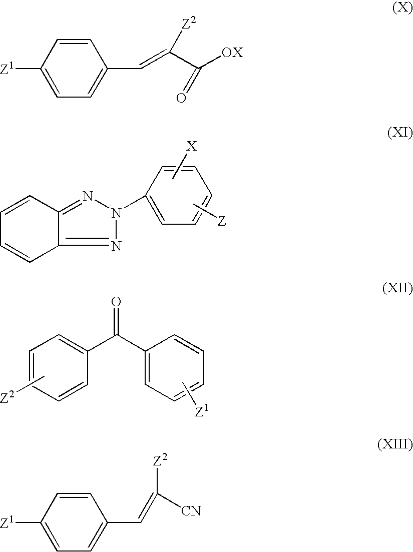

in bonded form.
In these, Z¹ and/or Z² bond to the functional groups B of the anchor group and are, independently of one another, Z or C—X, where X is a hydrogen atom, a straight-chain branched alkyl radical or a cycloalkyl radical having from 1 to 12 carbon atoms, and C and Z are as defined above.
Another active ingredient group is provided by benzofurans or indolenes. By way of example, these compounds are described in U.S. Pat. No. 4,325,863. In principle, benzofurans or indolenes are suitable as active ingredient groups if they bear functional groups which can react with the functional groups B of the anchor group. Examples of functional groups of this type are substituted amino, hydroxy, thiol, carboxy, isocyanato, or epoxy groups, or activated double bonds. Preference is given to hydroxy groups and substituted and unsubstituted amino groups. In another embodiment of the invention, the inventive stabilizers therefore comprise, as active ingredient group, in addition to the stabilizers (2a), (2b), and/or (2c), compounds of the general formula (XIV) in bonded form:

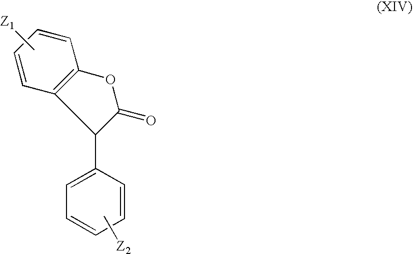

In these, Z¹ and/or Z² bond to the functional groups B of the anchor group and are, independently of one another, Z or C—X, where X is a hydrogen atom, a straight-chain or branched alkyl radical or a cycloalkyl radical having from 1 to 12 carbon atoms, and C and Z are as defined above.

### Auxiliary Groups

The inventive stabilizers may have one or more auxiliary groups (3).

For the purposes of the invention (3) is an auxiliary group which affects the processing, incorporation, emulsifiability, or solubility of the stabilizer for the purposes of the user. If, by way of example, the stabilizer is intended for dispersion in an aqueous solution, it can be helpful to incorporate an auxiliary group which increases the emulsifiability of the stabilizer. In contrast, in the case of use in hydrocarbon-containing solvents, it may be advantageous to increase the level of hydrophobic properties of the product, preferably by incorporating hydrophobic radicals as auxiliary group. Equally, it can be important for the processing of the stabilizer to lower the glass transition temperature and viscosity. An auxiliary group which can likewise be used here is one which inhibits accumulation of the stabilizer molecules to give aggregates and therefore reduces viscosity. Finally, the selection of the auxiliary group can also effect the solubility of the stabilizer for the purposes of the user. The result can be, for example, to reduce migration from the plastic into food or drink, or to control the distribution of the stabilizer in various polymer blends in favor of one of the two components of the blend. The nature of the structure of the auxiliary group (3) is very varied because the auxiliary group (3) can be required to carry out a wide variety of tasks.

The auxiliary group (3) is, like the active ingredient group (2), bonded to the polyisocyanate (1) by way of functional groups B which react with the NCO groups of the polyisocyanate (1). Examples of groups B are primary or secondary amino groups, hydroxy, thiol, carboxy, and epoxy groups. Preference is given to hydroxy groups and thiol groups, and also to primary or secondary amino groups.

By way of example, auxiliary groups with hydrophobic effect can have the following schematic structure:

B—S

In this context, S is a non-polar radical, e.g. a straight-chain, branched, or cyclic alkyl radical having from 1 to 10 000 carbon atoms, preferably from 2 to 500 carbon atoms, in particular from 4 to 50 carbon atoms.

Examples of S are straight-chain or branched aliphatic structures or aromatic structures, e.g. methyl, ethyl, propyl, butyl, pentyl, hexyl, heptyl, octyl, nonyl, decyl, dodecyl, stearyl, oleyl, palmityl, oligobutyl, oligobutadienyl, oligoisobutyl, polybutyl, polybutadienyl, polyisobutyl, phenyl, naphthyl, or nonylphenyl radicals. Examples of auxiliaries (B—S) with hydrophobicizing effect are stearic acid, oleic acid, palmitic acid, stearoyl chloride, octylamine, stearylamine, polyisobutyleneamine, dipentylamine, diisopentylamine, dihexylamine, octyl alcohol, stearyl alcohol, hexadecanol, octadecanol, octadecenol, polyisobutylene alcohol, nonylphenol, naphthol, benzyl alcohol, or phenylethanol.

If the auxiliary group is intended to have hydrophilicizing effect, (3) may have the following diagrammatic structure:

B-T

In this context, T is a radical with hydrophilicizing effect, e.g. a diethylene glycol monomethyl ether radical, a triethylene glycol monomethyl ether radical, an oligoethylene glycol monomethyl ether radical, a polyethylene glycol monomethyl ether radical, an oligopropylene glycol monomethyl ether radical, a polypropylene glycol monomethyl ether radical, or a poly(ethylene)(propylene) glycol monomethyl ether radical. Other radicals with hydrophilicizing effect are those of aminocarboxylic acids, hydroxycarboxylic acids, mercaptocarboxylic acids, aminosulfonic acids, hydroxysulfonic acids, mercaptosulfonic acids, hydroxyamine compounds, hydroxyammonium compounds, or hydroxyphosphonium compounds.

Examples of auxiliaries with hydrophilicizing effect are diethylene glycol monomethyl ether, triethylene glycol monomethyl ether, oligoethylene glycol monomethyl ether, polyethylene glycol monomethyl ether, oligopropylene glycol monomethyl ether, polypropylene glycol monomethyl ether, poly(ethylene)(propylene) glycol monomethyl ether, 2-methoxyethylamine, di(2-methoxyethyl)amine, 3-(2-methoxyethoxy)propylamine, 9-amino-3,6-dioxanonan-1-ol, or relatively high-molecular-weight polyalkylene oxide amines, well known as Jeffamine® from the company Huntsman, lactic acid, mercaptoacetic acid, hydroxypivalic acid, glycine, β-alanine, or taurine, diethanolamine, dipropanolamine, dibutanolamine, N,N-dimethylethanolamine, or N,N-diethylethanolamine.

The present invention also provides stabilizers (hereinafter also termed mixed stabilizers) composed of
(I) one or more polyisocyanates having an average of from 2 to 10, preferably from 2.1 to 10, particularly preferably from 2.2 to 8, isocyanate groups per molecule,
(II) per mole of isocyanate groups, from 0.1 to 1.0 mol in total of at least two different active ingredient groups, where one active ingredient group is based on phenol and the other active ingredient group is based on sterically hindered amines, and where the two active ingredient groups protect plastics from damage via heat, UV radiation, oxidation, hydrolysis or mechanical action during processing,
(III) per mole of isocyanate groups, from 0 to 0.9 mol of one or more auxiliary groups which modify the properties of the stabilizer, where the auxiliary groups have been coupled to the polyisocyanates by way of functional groups which can react with the isocyanate groups.

The statements made above relating to the stabilizers having non-mixed active ingredient groups are applicable to the individual active ingredient groups.

The present invention also provides the use of these mixed stabilizers for the stabilization of polyolefins, of polyamides, of polyurethanes, of polyacrylates, of polycarbonates, of polyesters, of polyoxymethylenes, of polystyrenes, and of styrene copolymers, and provides the use of these mixed stabilizers for the stabilization of dispersions, of lacquers, of coatings, of dyes, of adhesives, of food or drink, of pharmaceuticals, and of cosmetics.

Examples of ratios in which the inventive active ingredient groups may be used are

Molar amount of (2a)=from 0.05 to 0.95 mol, where molar amount of (2b)+molar amount of (other stabilizers)=from 0.95 to 0.05 mol
or
Molar amount of (2b)=from 0.05 to 0.95 mol, where molar amount of (2a)+molar amount of (other stabilizers)=from 0.95 to 0.05 mol.

### Synthesis of Inventive Stabilizers

The inventive stabilizers are usually prepared by way of a polyaddition reaction, by taking at least one polyisocyanate (1) as anchor group, where appropriate with concomitant use of an organic solvent, under an inert gas, preferably under nitrogen, as initial charge in a reaction vessel, and bringing this to reaction temperature, with stirring. At reaction temperature, at least one active ingredient (2) is then added, continuously or batchwise. The amount of active ingredient (2) depends on the number of NCO groups in the polyisocyanate (1), and is preferably selected in such a way that the ratio of the molar quantity of the isocyanate groups to the molar quantity of the groups A which are reactive toward these and are present in the active ingredient is in essence 1:1. If two or more active ingredients are reacted simultaneously or in succession with the polyisocyanate (1), or if another auxiliary (3) is added to prepare the inventive stabilizer after linking of the active ingredients (2), the total amount of the reactive groups A in the active ingredients (2) and of the reactive groups B in the auxiliaries (3) is adjusted so that it is in essence the same as the total amount of isocyanate groups.

However, the inventive stabilizers may also have up to 20 mol %, preferably up to 10 mol %, of free NCO groups, i.e. NCO groups which have not been consumed by reaction with an active ingredient (2) or with an auxiliary (3).

However, the inventive stabilizers preferably have in essence no free NCO groups.

The reaction time is generally selected in such a way that the NCO groups of the polyisocyanates (1) are reacted completely with the reactive groups A of the active ingredients and, where appropriate, with the reactive groups B of the auxiliaries.

Where appropriate, the abovementioned reaction with the active ingredient groups and with the auxiliaries may take place in the presence of catalysts, the amount used of these being from 0.0001 to 1% by weight, in particular from 0.001 to 0.1% by weight, based in each case on the amount of polyisocyanates (1). Catalysts which may be used for polyaddition reactions are organometallic compounds, especially organotin, organozinc, organotitanium, organobismuth, or organozirconium compounds. By way of example, it is particularly preferable to use dibutyltin dilaurate, dibutyltin oxide, titanium tetrabutylate, zinc acetylacetonate, or zirconium acetylacetonate. Use may also be made of strong bases, preferably nitrogen-containing compounds, such as tributylamine, quinuclidine, diazabicyclooctane, diazabicyclononane, diazabicyclononene, diazabicycloundecane, or diazabicycloundecene.

Suitable solvents which may be used are those which are inert toward the starting materials under reaction conditions. By way of example, suitable substances are acetone, 2-butanone, ethyl acetate, butyl acetate, tetrahydrofuran, dioxane, benzene, toluene, xylene, ethylbenzene, chlorobenzene, dichlorobenzene, dimethylformamide, dimethylacetamide, or N-methylpyrrolidone.

The reaction temperature for the polyaddition reaction is usually from −10 to 220° C., preferably from 0 to 180° C. The reaction takes place either at atmospheric pressure or else at a pressure above or below atmospheric pressure, for example at a pressure of from 2 to 20 bar, or at from 0.1 to 0.001 bar.

### Processes for Preparation of Molding Compositions

The molding compositions are preferably prepared via separate preparation of the individual components A), B) or B′) and B″), D), E), and F), and, if appropriate, C) and G), and of the stabilizers, and mixing of the components.

The graft polymer A) is preferably prepared by the process of emulsion polymerization, as described above. This gives an aqueous dispersion.

The resultant dispersion of the graft polymer A) may either by directly mixed with components B) or B′) and B″), D), E), and F), and also, if appropriate, C) and G), and with the stabilizer, or may first be worked up. The latter procedure is one of the preferred embodiments.

The dispersion of the graft polymer A) or A′) is worked up in a manner known per se. The usual method first precipitates the graft polymer A) or A′) from the dispersion, for example via addition of precipitant salt solutions (such as calcium chloride, magnesium sulfate, alaun) or acids (such as acetic acid, hydrochloric acid, or sulfuric acid), or else via freezing (freeze coagulation). Precipitation via high shear forces, known as shear precipitation, is also possible, these high shear forces being generated, by way of example, via rotor/stator systems, or passage of the dispersion under pressure through a narrow gap. The aqueous phase can be removed in the usual way, e.g. via sieving, filtering, decanting, or centrifuging. This prior removal of the dispersion water usually gives graft polymers A) or A′) moist with water, their residual water content being up to 60% by weight, based on A) or A′), and this residual water may, by way of example, adhere externally to the graft polymer and also may have been included therein.

The graft polymer may then, if required, be further dried in a known manner, e.g. via heat air or by means of a pneumatic dryer. Work-up of the dispersion via spray drying is also possible.

In one preferred embodiment, the graft polymers A) or A′) and the other components B) to G) or B′), B″) to G), and the stabilizer(s) are mixed in a mixing apparatus, giving a substantially molten polymer mixture.

“Substantially molten” means that the polymer mixture may also comprise, alongside the predominant, molten (softened) fraction, a certain fraction of solid constituents, such as non-molten fillers and non-molten reinforcing materials, e.g. glass fibers, metal flakes, non-molten pigments, dyes, etc. “Molten” means that the state of the polymer mixture is at least that of a very high-viscosity liquid, i.e. that it is at least sufficiently soft to possess plastic properties.

The mixing apparatus used comprises the apparatus known to the person skilled in the art. By way of example, components A) to G) or A′), B′), B″) to G), and the stabilizer(s) may be mixed by subjecting them jointly to extrusion, kneading, or rolling processes, and the components and the stabilizer(s) here may, if necessary, have been isolated in advance from the solution obtained during the polymerization process, or from the aqueous dispersion.

If one or more components is/are incorporated in the form of an aqueous dispersion or an aqueous or non-aqueous solution, the water or the solvent is removed from the mixing apparatus, preferably an extruder, by way of a devolatilizing unit.

Examples of mixing apparatus suitable for carrying out the inventive process are batchwise-operated, heated internal mixers with or without ram, continuous kneaders, e.g. continuous internal mixers, screw kneaders with axially oscillating screws, Banbury mixers, and also extruders and roll mills, mixing rolls with heated rolls, and calenders.

The mixing apparatus preferably used comprises an extruder. By way of example, single- or twin-screw extruders are particularly suitable for melt extrusion. A twin-screw extruder is preferred.

In some instances, the mechanical energy introduced via the mixing apparatus during the mixing process is sufficient to melt the mixture, and there is therefore no need to heat the mixing apparatus. Otherwise, the mixing apparatus is generally heated. The temperature depends on the chemical and physical properties of the components and of the stabilizer(s), and is to be selected in such a way as to give a substantially molten polymer mixture. On the other hand, in order to avoid thermal degradation of the polymer mixture the temperature is not to be unnecessarily high. However, the amount of mechanical energy introduced may even be so high as to require cooling of the mixing apparatus. The mixing apparatus is usually operated at 150 to 300° C., preferably from 180 to 300° C.

In one preferred embodiment, the mixing of the graft polymer A) or A′) with the polymer B) or B′) and B″), and with the other components C) to G)—if they are present—and also with the stabilizer(s) takes place in an extruder, the dispersion of the graft polymer being fed directly into the extruder without prior removal of the dispersion water. The water is usually removed along the extruder by way of suitable vents. Examples of vents that may be used are vents provided with retaining screws (which prevent discharge of the polymer mixture).

In another embodiment, likewise preferred, the mixing of the graft polymer A) or A′) with the polymer B) or B′) and B″) and with the other components C) to G)—if they are present—and with the stabilizer(s) takes place in an extruder, the graft polymer having been separated from the dispersion water in advance, e.g. via sieving, filtering, decanting, or centrifuging. This prior removal of the dispersion water gives graft polymers moist with water, their residual water content being up to 60% by weight, based on A) or A′), and the residual water here may, by way of example, either adhere externally to the graft polymer or else have been included therein. The residual water present may then, as described above, be removed as steam by way of extruder vents.

However, in one particularly preferred embodiment the residual water is not solely removed in the form of stream in the extruder, but instead a portion of the residual water is removed mechanically in the extruder and leaves the extruder in the liquid phase. For this, retarding elements are used to build up pressure in the extruder and this pressure squeezes the water out of the polymer. It flows out via vents in the form of liquid water. The polymer B) or B′) and the other components C) to G)—if they are present—and also the stabilizer(s), can be introduced into the same extruder, so that the finished molding composition is extruded as product of the process.

Further details concerning this process can be found, by way of example, in WO-A 98/13412, which is expressly incorporated herein by way of reference and whose disclosure content in this connection is expressly incorporated into the present invention by way of reference.

However, it is also possible to begin, as described immediately above, by dewatering the graft polymer A) or A′) via a squeezing process in the extruder, and to mix the dewatered graft polymer in a second extruder or in another mixing apparatus with the other components B) to G) or B′), B″) to G), and with the stabilizer(s).

If an extruder is used for the squeezing process or as a mixing apparatus, it is then possible, as is well known, for the various zones of an extruder to be individually heated or cooled, in order to set an ideal temperature profile along the axis of the screw. Another matter familiar to the person skilled in the art is that the individual sections of the extruder can usually be of different length.

The temperatures and lengths to be chosen for the individual sections in a particular case differ, depending on the chemical and physical properties of the components used and of the stabilizer(s), and of the quantitative portions of these. This also applies to the screw rotation rate, which can vary within a wide range. Extruder screw rotation rates in the range from 100 to 1200 rpm, preferably from 100 to 350 rpm, may be mentioned merely by way of example.

In one preferred embodiment, the substantially molten polymer mixture prepared in the mixing apparatus from the components used and from the stabilizer(s) is subjected to rapid cooling.

The rapid cooling is usually carried out by bringing the substantially molten polymer mixture (the abbreviated term “polymer melt” being used below) into contact with a cold fluid or with a cold surface.

“Cold” here means a temperature which is sufficiently far below that of the polymer melt that the polymer melt cools rapidly when contact is made. “Cold” therefore does not always mean cooled. By way of example, a polymer melt at 200° C. may be subjected to rapid cooling by water which has previously been heated to, for example, from 30 to 90° C. The decisive factor is that the difference between the polymer melt temperature and the temperature of the cold fluid or surface is sufficient for rapid cooling of the melt.

“Rapid” means that within a period of from 0 to 10 sec, preferably up to 5 sec, and particularly preferably up to 3 sec, the polymer melt is transformed from the molten to the solid state and cooled.

The polymer melt is preferably cooled rapidly using a cold medium. These fluids may be gases or liquids.

Examples of cold gaseous fluids (termed “cooling gases” below) are cooled or uncooled air or, particularly for polymer melts which are easily oxidized, gases such as carbon dioxide, nitrogen, or noble gases. Air or nitrogen is preferably used as cooling gas. The cooling gas is generally blown onto the polymer melt as it emerges from the mixing apparatus.

Cold liquids (termed “cooling liquids” below) may be organic or inorganic cooling liquids. Examples of suitable organic cooling liquids are oils and other high-boiling liquid organic materials which do not interact chemically or physically (e.g. by swelling, solvent attack, etc.) with the polymer melt to be cooled, i.e. are chemically and physically inert with respect to the polymer melt.

It is preferable to use inorganic cooling liquids, in particular aqueous solutions and water. Particular preference is given to water, which may be used cooled (freezing point to room temperature), uncooled, or heated (room temperature to boiling point).

The cooling liquid is generally sprayed onto the polymer melt as it emerges; or the polymer melt emerges from the mixing apparatus directly into a bath of the cooling liquid. It is also possible to apply the cooling liquid in the form of a wide jet of liquid (flood) onto the polymer melt as it emerges.

Spraying of the polymer melt with cooling liquid is particularly advantageous when the mixing apparatus used is one which produces sheeting (for example roll mills, mixing rolls, and calenders). The polymer melt emerging in the form of a film solidifies when sprayed with cooling liquid, to give sheeting.

The polymer melt is particularly preferably discharged directly from the mixing apparatus into a bath of the cooling liquid, very particularly preferably into a water bath.

It is also possible, and in some cases preferable, for the polymer melt emerging from the mixing apparatus to be first only slightly cooled by bringing it into contact with a cooling gas, for example by blowing temperature-controlled air, or an inert gas such as nitrogen, onto the material. This solidifies only the outer surface of the melt, while the interior of the polymer remains molten. The actual rapid cooling is then carried out by bringing the melt, previously solidified at the surface, into contact with a cooling liquid, e.g. water, whereupon the interior of the melt also hardens.

By way of example, the polymer melt extrudates emerging from the die head of the extruder may initially be solidified superficially by contact with blown air and may then be passed into a water bath, where the actual rapid cooling takes place.

The polymer melt hardened by the rapid cooling may be further processed in a manner known to the person skilled in the art. The solidified polymer is generally comminuted by grinding, chopping, granulating, or other processes.

In one particularly preferred embodiment, the rapid cooling and the comminution are achieved by underwater pelletization. In underwater pelletization, the polymer melt is discharged from the mixing apparatus via a die plate in which the holes (dies) are preferably round and arranged in the shape of a circle. The die plate is located underwater (or under another cooling liquid) or is sprayed with water (or with another cooling liquid), and this may take place under an inert gas. Immediately downstream of the die plate, on its outer side, there are cutting devices, preferably rotating knives, which separate the polymer as it is discharged. The polymer is therefore separated by rotating knives and rapidly cooled in water (or another cooling liquid), generally solidifying to give bead-like, to some extent round, granules.

However, non-circular arrangements of the holes and non-round shapes of the holes are also commonly found in the die plate.

In another embodiment, the process used is known as underwater strand pelletization. In this process, the melt emerges in the form of a strand from a die plate and is immediately wetted by a flood of water or coolant and thus rapidly cooled, and then the strands are introduced, via a sloping plane, into a water bath or coolant bath, and are pelletized after cooling.

In one particularly preferred embodiment, an extruder is used as mixing apparatus for the components used with the underwater pelletization just described. In this embodiment, therefore, the discharge aperture of the extruder is a die plate located underwater (or sprayed with water) with cutting devices, in particular with rotating knives.

A preferred preparation process is therefore one which comprises
1) preparation of the graft copolymer A) or A′) by the process of emulsion polymerization,
2) mixing of the graft polymer A) or A′) with the hard copolymer B) or, if present, B′) and B″), and with the stabilizer(s), and, if appropriate, with the other components C) to G) in a mixing apparatus, the product being a substantially molten polymer mixture,
3) rapid cooling of the substantially molten polymer mixture within a period of 10 sec.

Particularly preferred thermoplastic molding compositions comprise the abovementioned components A), B), or B′) and B″), D), E), F), G), and, if appropriate, C), and the stabilizer(s), and butadiene as conjugated diene a11), obtainable via
1) preparation of the graft polymers A) or A′) by the process of emulsion polymerization, obtaining a water-moist polymer A) or A′) which comprises up to 60% by weight, based on A) or A′), of residual water,
2) mixing of the water-moist graft polymer A) or A′) with the other components B) to G) or B′), B″) to G), and with the stabilizer(s) in an extruder, producing a substantially molten polymer mixture, and squeezing out at least 30% by weight of the residual water, in the form of liquid water, of the water-moist graft polymer A) or A′) via build-up of pressure in the extruder,
3) rapid cooling of the substantially molten polymer mixture via the process of underwater pelletization within a period of 10 sec.

In another particularly preferred embodiment, the additives C) to G) and the stabilizer(s) are added at various junctures within the preparation process. By way of example, the stabilizer(s) and one or more of components C) to G) may be added to the aqueous dispersion/emulsion of the graft copolymer A) or A′) at an early stage in the process (prior to, during, or after the polymerization reaction of A) or A′)), the remaining components being added at a subsequent juncture, for example during the mixing process in the extruder or in other mixing apparatus.

In another particularly preferred embodiment, one, two or more, or all of the additives C) to G) and of the stabilizer(s) is/are divided into two or more portions and these portions are added at various junctures within the preparation process. By way of example, one portion of components D) and E) may be added to the aqueous dispersion/emulsion of the graft copolymer A) or A′) at an early stage in the process (prior to, during, or preferably after the polymerization reaction of A) or A′)), addition of the remaining portion being delayed until subsequently during the mixing of components A) or A′) to G) and the stabilizer(s) in the extruder or in other mixing apparatus.

It is very particularly preferable to add a portion of component D) and a portion of component E) to the dispersion/emulsion of the graft copolymer A) or A′), and to add the remaining portion of D) and E) during the mixing of components A) to G) and the stabilizer(s) in the extruder.

It is preferable that at least that portion of D) and E) which is added to the graft copolymer dispersion takes the form of an aqueous dispersion, meaning that a dispersion of D) and E) is added (in the form of a mixture or separately in two dispersions) to the dispersion of A) or A′).

The proportion of component D) which is added to the aqueous dispersion/emulsion of the graft copolymer A) or A′) at an early stage in the process is preferably from 20 to 100% by weight, based on the total amount of D). For component E), the corresponding proportion is preferably from 30 to 100% by weight, based on the total amount of E).

Another preferred preparation process is therefore one which comprises
1) preparation of the graft copolymer A) or A′) by the process of emulsion polymerization,
2) addition of a portion or the entire amount of component D) and a portion or the entire amount of component E) to the aqueous dispersion or emulsion prior to, during, or after the polymerization reaction of A) or A′),
3) addition of any remaining portion, if present, of components D) and E), into a mixing apparatus in which components A), B), or A′), and, if present, B′) and/or B″), and, if appropriate, C), E), F), G) and the stabilizer(s) are mixed, the product being a substantially molten polymer mixture,
4) rapid cooling of the substantially molten polymer mixture within a period of 10 sec,
   components D) and E) being present in the inventive molding compositions.

Additional additives are used at junctures known per se to the person skilled in the art.

Unless otherwise described or apparent from the context, B) means the compounds B), B′) or B″). In particular, components A) to G) means components A), B), C), D), E), F), and G) of the first embodiment, and components A), B′), B″), C), D), E), F), and G) of the second embodiment.

### Properties of Molding Compositions

The inventive molding compositions feature very good weathering resistance, together with a balanced profile of mechanical properties, in particular high toughness, even after weathering or after heat-aging. The good weathering resistance or heat-aging resistance is therefore not detrimental to mechanical properties. The inventive molding compositions exhibit very little change in shade on weathering or after heat-aging, and exhibit very little dust marking in dusty environments. They have improved colorant dispersion, and also improved demoldability during injection molding.

The molding compositions can be used to produce moldings, fibers, and foils of any type. The inventive thermoplastic molding compositions may be processed by the known methods of thermoplastics processing, e.g. via extrusion, injection molding, calendering, blow molding, compression molding, or sintering.

When the average particle size d is stated, this is the weight-average particle size as determined by the method of W. Scholtan and H. Lange, Kolloid-Z. und Z.-Polymere 250 (1972) pp. 782-796, using an analytical ultracentrifuge. The ultracentrifuge measurement gives the cumulative weight distribution of the particle diameter of a specimen. From this it is possible to deduce the percentage by weight of particles whose diameter is equal to or smaller than a certain size.

The d₁₀ value gives that particle diameter relative to which the diameter of 10% by weight of all of the particles is smaller and that of 90% by weight is larger. Conversely, for the d₉₀ value, the diameter of 90% by weight of all the particles is smaller, and that of 10% by weight is larger, than the diameter corresponding to the d₉₀ value. The weight-average particle diameter d₅₀ and the volume-average particle diameter d₅₀ are those particle diameters relative to which the diameter of 50% by weight and, respectively, 50% by volume of all of the particles is smaller. The d₁₀, d₅₀, and d₉₀ values describe the breadth Q of the particle size distribution, where Q=(d₉₀−d₁₀)/d₅₀. Smaller Q means narrower distribution.

The present invention is further illustrated by the examples described below:

### EXAMPLE 1

### Preparation of a Hyperbranched Polyisocyanate

1000 g of isophorone diisocyanate (IPDI) are used as initial charge under a stream of nitrogen in a reaction vessel with stirrer, gas inlet tube, and dropping funnel, with pressure equalization, and 300 g of trimethylolpropane dissolved in 1300 g of dry ethyl acetate are added within a period of 1 min at room temperature, with good stirring. After addition of 0.1 g of dibutyltin dilaurate, the reaction mixture is heated to 60° C., with stirring, and the fall-off of NCO content is followed titrimetrically. When the NCO content has reached 5.5% by weight, the reaction product has an average NCO functionality of 3 and an average OH functionality of 1.430 g of BASONAT HI 100 dissolved in 430 g of dry ethyl acetate are then added to the adduct within a period of 1 min, and the mixture is stirred for a further 3 h at 60° C. The final product has an NCO content of 5.5% by weight.

The average molar mass of the polyisocyanate is calculated as about 2850 g/mol, the average NCO functionality being about 7.4.

BASONAT® HI 100 (BASF AG): aliphatic polyisocyanate based on hexamethylene diisocyanate, average functionality being 3.7 NCO groups per molecule.

### EXAMPLE 2

### Preparation of a Phenolic Active Ingredient Module

609 g of Pluriol® E 200 (BASF AG), 175 g of Ralox® 35 (Raschig) and 2.8 g of Weston® DHOP (General Electric) are added to a 500 ml round-bottomed flask with stirrer, gas inlet tube, and distillation bridge, under a stream of dry nitrogen. The mixture is heated to 145° C., and 1.8 g of potassium methanolate are added. The resultant methanol is removed by way of the distillation bridge and collected in a cold trap.

Once methanol liberation has been completed at 145° C. (about 2 h), the reaction mixture is cooled to 80° C. 2.5 g of 85% strength phosphoric acid are then added to neutralize the product. Stirring is continued at 80° C. for a further 15 min and then the mixture is washed with water. For this, 1000 ml of distilled water are heated to 40° C. in a glass beaker, and the product, whose temperature is 80° C., is slowly added to the water, with vigorous stirring. The aqueous mixture is then stirred for 30 min, and allowed to stand until the phases separate, and the aqueous phase is decanted from the product. This washing procedure is repeated once. The product is then dried at 10 bar and about 80° C. on a rotary evaporator.

### EXAMPLE 3

### Inventive Stabilizer (HALS)

800 g of the solution of the hyperbranched polyisocyanate in ethyl acetate from example 1 are used as initial charge at room temperature under a stream of nitrogen in a reaction vessel with stirrer, gas inlet tube, and dropping funnel, with pressure equalization, and 180 g of 1,2,2,6,6-pentamethylpiperidin-4-ol dissolved in 180 g of dry ethyl acetate are added within a period of 2 min. After addition of 0.5 g of dibutyltin dilaurate, the mixture is stirred at 60° C. for 6 h. 100 g of methanol are then added and the mixture is stirred at 60° C. for a further 2 h in order to neutralize residues of isocyanate groups. The solvents are then removed in vacuo on a rotary evaporator. The molar mass of the product is calculated as about 4115 g/mol, its average number of active HALS ingredient groups per molecule being 7.4.

### EXAMPLE 4

### Inventive Stabilizer (phenol)

400 g of the solution of the polyisocyanate in ethyl acetate from example 1 are used as initial charge at room temperature under a stream of nitrogen in a reaction vessel with stirrer, gas inlet tube, and dropping funnel, with pressure equalization, and 200 g of the active phenolic ingredient module from example 2, dissolved in 200 g of dry ethyl acetate, are added within a period of 2 min. After addition of 0.5 g of dibutyltin dilaurate, the mixture is stirred at 60° C. for 8 h in order to neutralize residues of isocyanate groups. The solvents are then removed in vacuo on a rotary evaporator. The molar mass of the product is calculated as about 5650 g/mol, its average number of active phenolic ingredient groups per molecule being 7.4.

### EXAMPLE 5

### Inventive Stabilizer (PU-HALS-phenol)

600 g of the solution of the polyisocyanate in ethyl acetate from example 2 are used as initial charge at room temperature under a stream of nitrogen in a reaction vessel with stirrer, gas inlet tube, and dropping funnel, with pressure equalization, and 100 g of the phenol from example 3, dissolved in 100 g of dry ethyl acetate, are added dropwise within a period of 1 min. After addition of 0.5 g of dibutyltin dilaurate, the mixture is stirred at 60° C. for 6 h. 90 g of 1,2,2,6,6-pentamethylpiperidin-4-ol, dissolved in 90 g of dry ethyl acetate, are then added and the mixture is again stirred at 60° C. for 6 h. 50 g of methanol are then added and the mixture is stirred at 60° C. for 2 h in order to neutralize residues of isocyanate groups. The solvent is then removed in vacuo on a rotary evaporator. The molar mass of the product is calculated as about 4630 g/mol, its average number of active phenolic ingredient groups being 2.5 per molecule and its average number of active HALS ingredient groups being 4.9 per molecule.

The inventive stabilizers may be either incorporated into the rubber dispersion and worked up together therewith, or else incorporated in the extruder.

For comparison or for completeness, Tinuvin 770, Tinuvin P, Wingstay L, and BB12P are used.

Tinuvin 770 (Ciba®): [bis(2,2,6,6-tetramethyl-4-piperidinyl)sebacate], Tinuvin P (Ciba®): 2-(2-hydroxy-5-methylphenyl)benzotriazole, Wingstay L (4,4′-thiobis(6-tert-butyl-m-cresol); BB12P.

The PU-phenol, PU-HALS, and PU-phenol-HALS stabilizers were incorporated in two ways into ASA polymers: a) into the rubber dispersion, and b) in the extruder. The material is extruded and then studied by analytical methods known to the person skilled in the art (injection molding, impact test, etc).

### Stabilizer Based on Sterically Hindered Phenol (PU-phenol)

PU-phenol is incorporated in the form of powder into the rubber dispersion and then precipitated together with the rubber, using MgSO₄. The resultant mixture composed of moist rubber and stabilizer is dewatered in an extruder and simultaneously mixed with SAN and with other stabilizers (Tinuvin 770, Tinuvin P). Comparative tests use blends with BB12P and Wingstay L (formulation in table 1).

TABLE 1
Phenolic stabilizers: formulation of inventive examples and of
comparative examples

| | | Phenolic | | | % by | UV | % by |
|---|---|---|---|---|---|---|---|
| | | stabilizer | % by weight | HALS | weight | absorber | weight |
| 114-5 | C | BB12P | 0.2 | Tinuvin 770 | 0.5 | Tinuvin P | 0.5 |
| 114-8 | C | Wingstay L | 0.2 | Tinuvin 770 | 0.5 | Tinuvin P | 0.5 |
| 114-9 | I | PU-Phenol | 0.2 | Tinuvin 770 | 0.5 | Tinuvin P | 0.5 |
| 114-11 | I | PU-Phenol | 0.1 | Tinuvin 770 | 0.5 | Tinuvin P | 0.5 |

C = Comparative example,
I = Inventive example

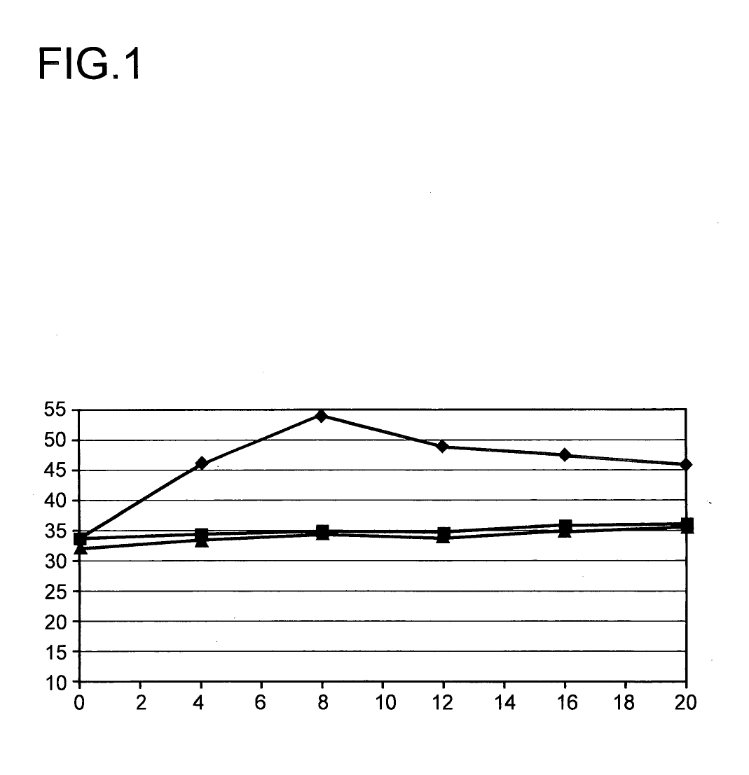

The inventive blends using PU-phenol (0.1% and 0.2%) are heat-aged for 20 weeks (90° C.), and also irradiated with UV light for 4000 h. The results of this weathering are given in the graphs of FIGS. 1-4 and in table 2.

FIG. 1 shows yellowness index for PU-phenol after heat-aging at a temperature of 90° C. Aging time in weeks is shown on the abscissa, and yellowness index is shown on the ordinate. The following formulations are shown:

| | | |
|---|---|---|
| Square: | 114-5 | Tinuvin 770 (0.5%), BB12P (0.2%) |
| Diamond: | 114-8 | Tinuvin 770 (0.5%), Wingstay L (0.2%) |
| Triangle: | 114-11 | Tinuvin 770 (0.5%), PU-phenol (0.1%) |
| Circle: | 114-9 | Tinuvin 770 (0.5%), PU-phenol (0.2%) |

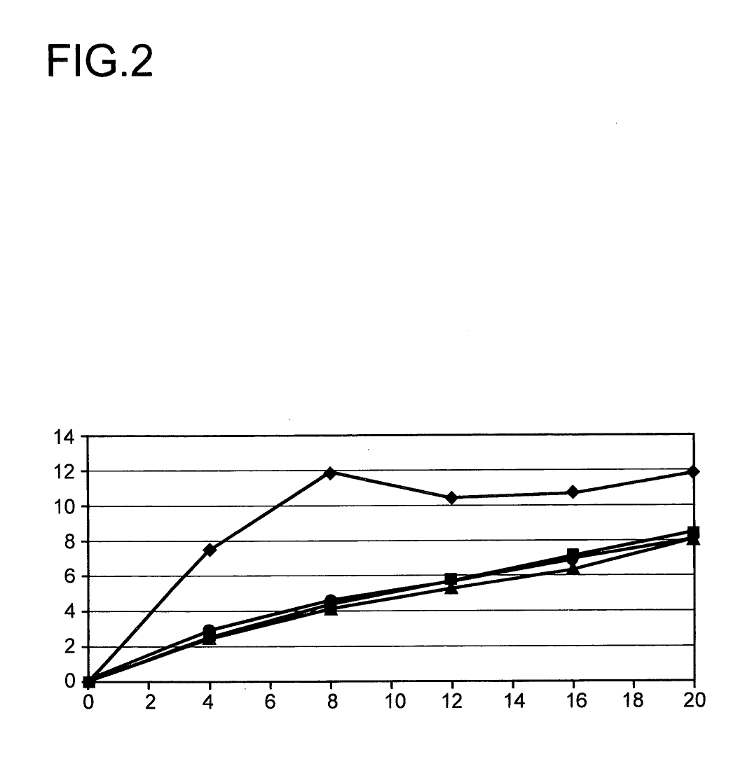

FIG. 2 shows the deviation value of PU-phenol after heat-aging at a temperature of 90° C. Aging time in weeks is shown on the abscissa, and deviation value is shown on the ordinate. The following formulations are shown;

| | | |
|---|---|---|
| Square: | 114-5 | Tinuvin 770 (0.5%), BB12P (0.2%) |
| Diamond: | 114-8 | Tinuvin 770 (0.5%), Wingstay L (0.2%) |
| Triangle: | 114-11 | Tinuvin 770 (0.5%), PU-Phenol (0.1%) |
| Circle: | 114-9 | Tinuvin 770 (0.5%), PU-Phenol (0.2%) |

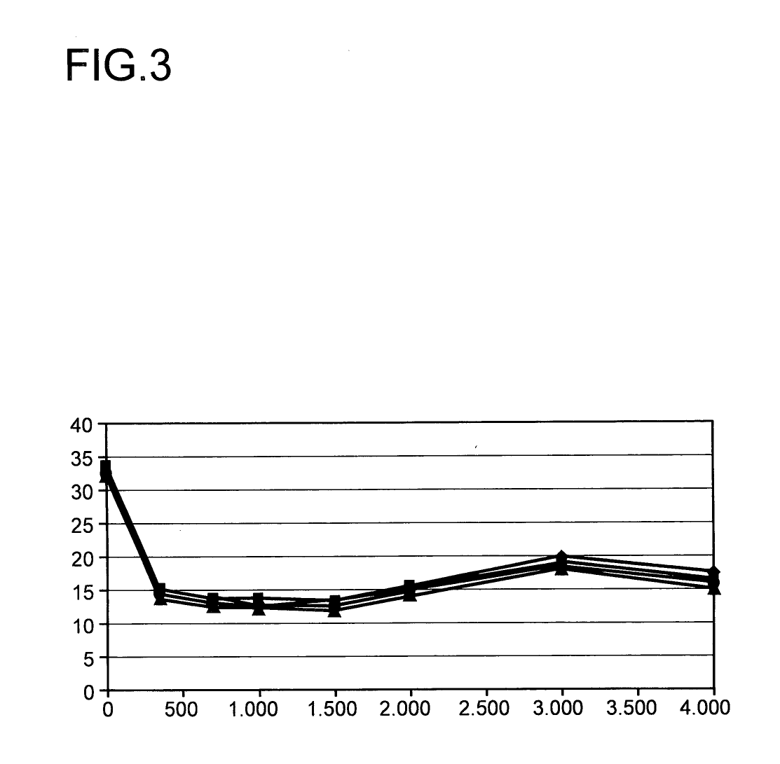

FIG. 3 shows the Xenotest 1200 CPS yellowness index for PU-phenol. Aging time in hours is shown on the abscissa and yellowness index is shown on the ordinate. The following formulations are shown:

| | | |
|---|---|---|
| Square: | 114-5 | Tinuvin 770 (0.5%), BB12P (0.2%) |
| Diamond: | 114-8 | Tinuvin 770 (0.5%), Wingstay L (0.2%) |
| Triangle: | 114-11 | Tinuvin 770 (0.5%), PU-Phenol (0.1%) |
| Circle: | 114-9 | Tinuvin 770 (0.5%), PU-Phenol (0.2%) |

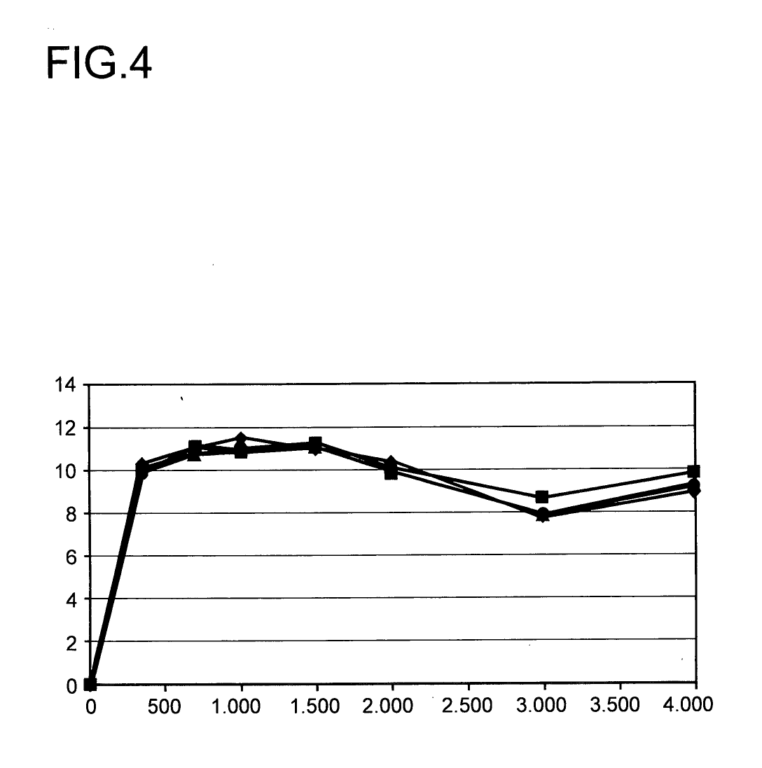

FIG. 4 shows the Xenotest 1200 CPS deviation value for PU-phenol. Aging time in hours is shown on the abscissa and deviation value is shown on the ordinate. The following formulations are shown:

| | | |
|---|---|---|
| Square: | 114-5 | Tinuvin 770 (0.5%), BB12P (0.2%) |
| Diamond: | 114-8 | Tinuvin 770 (0.5%), Wingstay L (0.2%) |
| Triangle: | 114-11 | Tinuvin 770 (0.5%), PU-Phenol (0.1%) |
| Circle: | 114-9 | Tinuvin 770 (0.5%), PU-Phenol (0.2%) |

TABLE 2
Summary of stabilizing action of phenolic stabilizers compared with
standard blend (standard blend: Tinuvin 770, BB12P, Tinuvin P)

| | | PU-phenol | PU-phenol |
|---|---|---|---|
| Amount of stabilizer used | [% by weight] | 0.2 | 0.1 |
| Mechanical properties | | ◯ | ◯ |
| Rheological properties | | ◯ | ◯ |
| UV aging | Yellowness index | ◯ | ◯ |
| | Color deviation | ◯ | ◯ |
| Heat-aging | Yellowness index | ◯ | ◯ |
| | Color deviation | ◯ | ◯ |
| Stabilizing action per | | ◯ | ++ |
| % by weight | | | |

Scale:
++ very much better than comparative example
+ better than comparative example
◯ equivalent to comparative example
− poorer than comparative example
−− very much poorer than comparative example

FIGS. 1 to 4 illustrate that the inventive resin using PU-phenol exhibits substantially identical yellowness index and also identical color deviation when compared with the comparative example using BB120 in heat-aging and in the Xenotest 1200 CPS (weather resistance test). Identical stabilizing action is achieved in an inventive example, but even when a very small amount of stabilizer is used: 0.1% by weight.

### Stabilizer Based on Sterically Hindered Amine (PU-HALS)

The inventive PU-HALS stabilizer is incorporated together with other stabilizers in the extruder. A blend using Tinuvin 770 was prepared as corresponding comparative example (formulation in table 3).

TABLE 3
HALS stabilizers: formulation of inventive and comparative examples

| | | | | Phenolic | | UV | % by |
|---|---|---|---|---|---|---|---|
| | | HALS | % by weight | stabilizer | % by weight | absorber | weight |
| 114-5 | C | Tinuvin 770 | 0.5 | BB12P | 0.2 | Tinuvin P | 0.5 |
| 114-6 | I | PU-HALS | 0.25 | BB12P | 0.2 | Tinuvin P | 0.5 |
| 114-7 | I | PU-HALS | 0.5 | BB12P | 0.2 | Tinuvin P | 0.5 |

C = Comparative example,
I = Inventive example

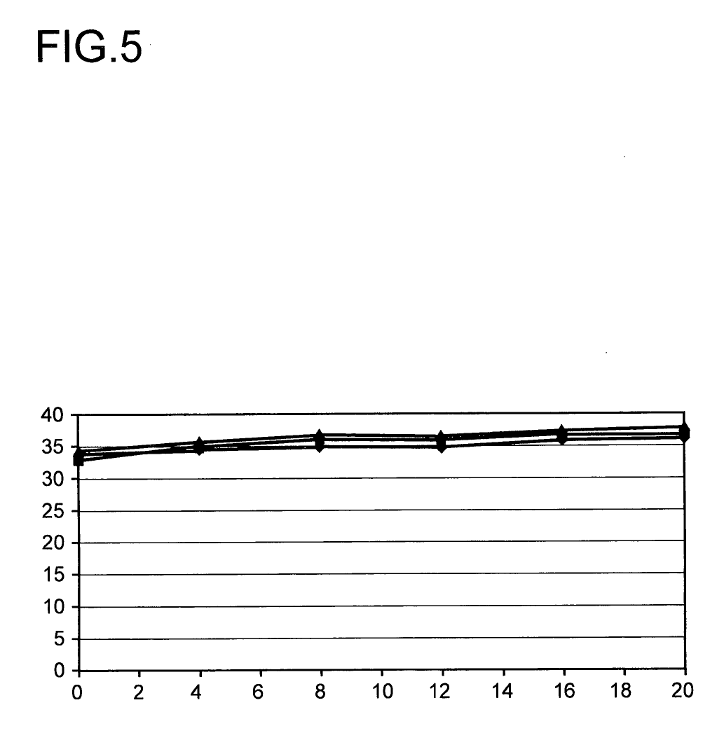

The inventive blends using PU-HALS (0.25% and 0.5%), and also the comparative example, are heat-aged (90° C.) for 20 weeks, and also irradiated with UV light for 4000 h. The results of this weathering are shown in the graph of FIGS. 5 to 8 and are given in table 4.

FIG. 5 shows yellowness index for PU-HALS after heat-aging at a temperature of 90° C. Aging time in weeks is shown on the abscissa, and yellowness index is shown on the ordinate. The following formulations are shown:

| | | |
|---|---|---|
| Square: | 114-6 | PU-HALS (0.25%), BB12P (0.2%) |
| Diamond: | 114-5 | Tinuvin 770 (0.5%), BB12P (0.2%) |
| Triangle: | 114-71 | PU-HALS (0.5%), BB12P (0.1%) |

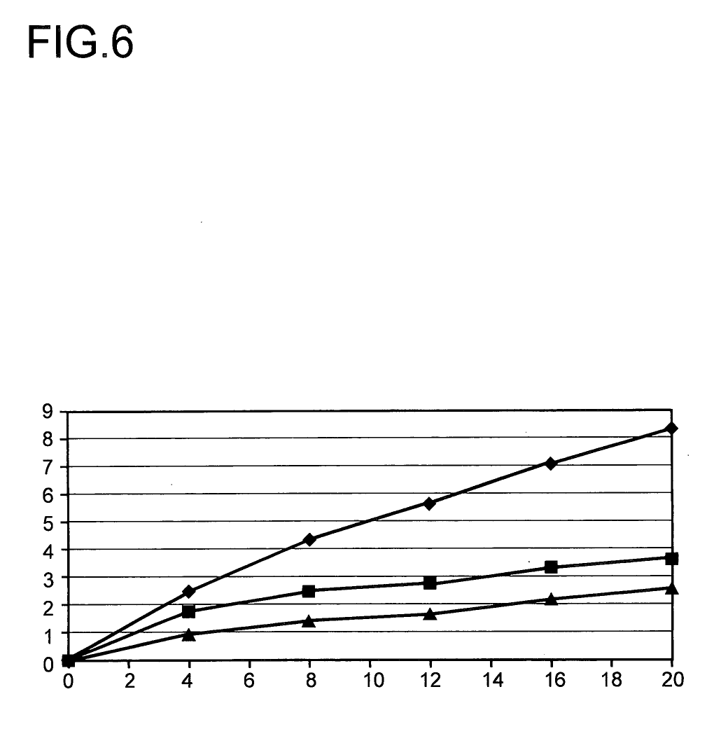

FIG. 6 shows the deviation value of PU-HALS after heat-aging at a temperature of 90° C. Aging time in weeks is shown on the abscissa, and deviation value is shown on the ordinate. The following formulations are shown;

| | | |
|---|---|---|
| Square: | 114-6 | PU-HALS (0.25%), BB12P (0.2%) |
| Diamond: | 114-5 | Tinuvin 770 (0.5%), BP12P (0.2%) |
| Triangle: | 114-7 | BP-HALS (0.5%), BB12PI (0.1%) |

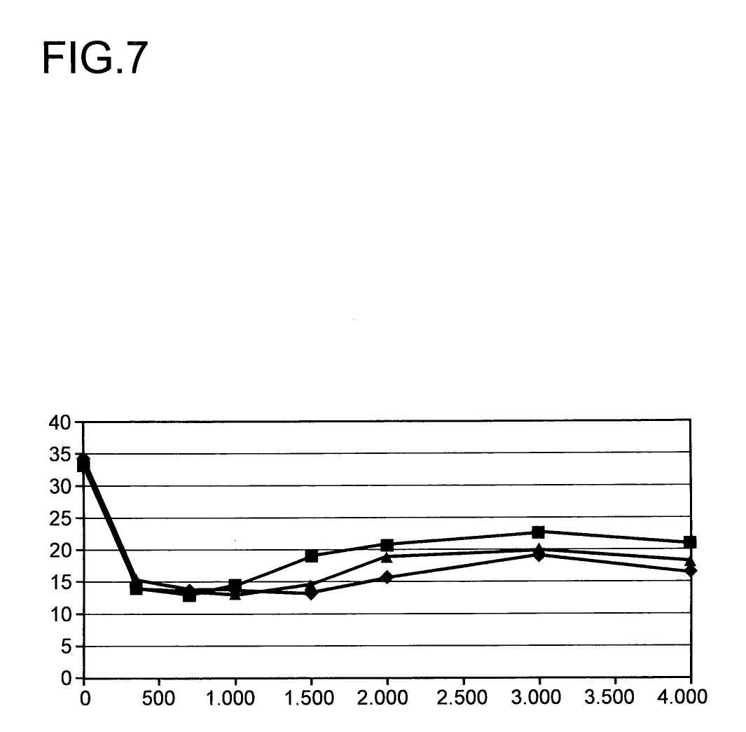

FIG. 7 shows the Xenotest 1200 CPS yellowness index for PU-HALS. Aging time in hours is shown on the abscissa and yellowness index is shown on the ordinate. The following formulations are shown:

| | | |
|---|---|---|
| Square: | 114-6 | PU-HALS (0.25%), BB12P (0.2%) |
| Diamond: | 114-5 | Tinuvin 770 (0.5%), BB12P (0.2%) |
| Triangle: | 114-7 | PU-HALS (0.5%), BB12P (0.2%) |

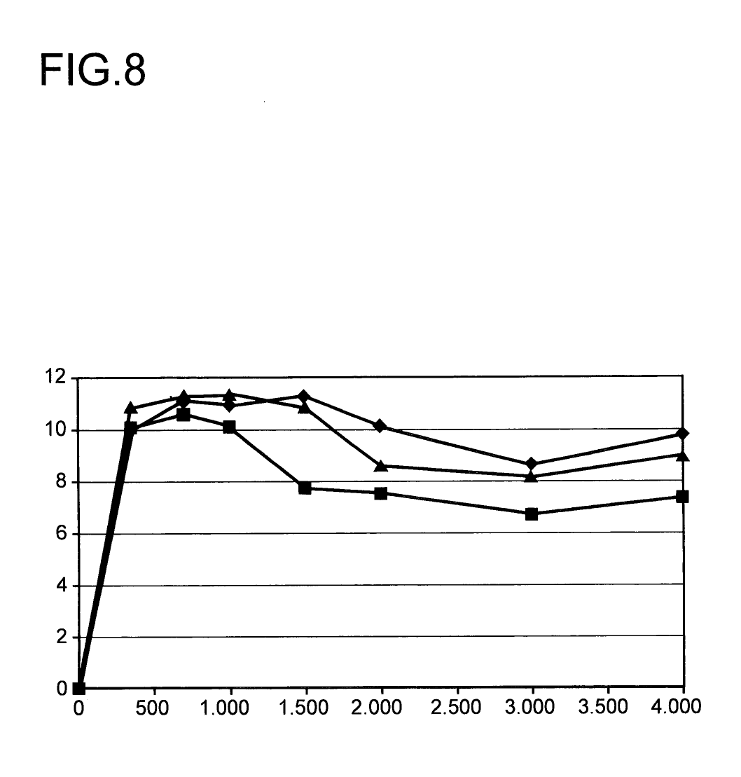

FIG. 8 shows the Xenotest 1200 CPS deviation value for PU-HALS. Aging time in hours is shown on the abscissa and deviation value is shown on the ordinate. The following formulations are shown:

| | | |
|---|---|---|
| Square: | 114-6 | PU-HALS (0.25%), BB12P (0.2%) |
| Diamond: | 114-5 | Tinuvin 770 (0.5%), BB12P (0.2%) |
| Triangle: | 114-7 | PU-HALS (0.5%), BB12P (0.2%) |

The inventive PU-HALS stabilizer exhibits markedly improved stabilizing action when compared with the comparative example using Tinuvin 770. Whereas after heat-aging PU-HALS and Tinuvin continue to show similar action with respect to yellowing (FIG. 5), a marked advantage for PU-HALS is discernible in color deviation dE (FIG. 6). Color deviation dE rises to only 2.5 after 20 weeks of heat-aging, whereas dE rises above 8 for the blend using Tinuvin 770. The advantages of PU-HALS are likewise discernible in the Xenotest. The yellowness indices determined after 4000 hours of UV irradiation are at the same level, whereas an advantage for PU-HALS is discernible in color deviation dE. Even the blend using 0.25% of PU-HALS exhibits better stabilizing action than Tinuvin P (0.5%), but this is somewhat better still when the concentration of PU-HALS used is 0.5%.

TABLE 4
Summary of stabilizing action of HALS stabilizers compared with
standard blend (standard blend: Tinuvin 770, BB12P, Tinuvin P)

| | | PU-HALS | PU-HALS |
|---|---|---|---|
| Amount of stabilizer | [% by weight] | 0.25 | 0.5 |
| used | | | |
| Mechanical properties | | ◯ | ◯ |
| Rheological properties | | ◯ | ◯ |
| Xenotest 12000 CPS | Yellowness index YI | ◯ | ◯ |
| | Color deviation dE | + | ◯ |
| Heat-aging | Yellowness index YI | ◯ | ◯ |
| | Color deviation dE | ++ | ++ |
| Stabilizing action per % | | + | + |
| by weight | | | |

Scale:
++ very much better than comparative example
+ better than comparative example
◯ equivalent to comparative example
− poorer than comparative example
−− very much poorer than comparative example

Inventive Stabilizer Based on Sterically Hindered phenol and HALS (PU-phenol-HALS)

The inventive PU-phenol-HALS stabilizer was incorporated in the extruder (examples 114-2,3,4). In another embodiment, the inventive PU-phenol-HALS stabilizer is added in the form of a dispersion to the rubber dispersion, and precipitated together therewith, and then incorporated in the extruder (example 114-12).

As comparison, a blend using Tinuvin 770 and BB12P is shown. The formulations are given in table 5.

TABLE 5
Phenol/HALS stabilizers: formulation of inventive examples and of
comparative example

| | | | | % by | | % by | Phenolic | % by | UV | % by |
|---|---|---|---|---|---|---|---|---|---|---|
| 114- | * | ** | | weight | HALS | weight | Stabilizer | weight | absorber | weight |
| 2 | I | Ex | PU-phenol- | 0.5 | — | — | — | — | Tinuvin P | 0.5 |
| | | | HALS | | | | | | | |
| 3 | I | Ex | PU-phenol- | 0.25 | — | — | — | — | Tinuvin P | 0.5 |
| | | | HALS | | | | | | | |
| 4 | I | Ex | PU-phenol- | 1 | — | — | — | — | Tinuvin P | 0.5 |
| | | | HALS | | | | | | | |
| 12 | I | D | PU-phenol- | 0.5 | — | — | — | — | Tinuvin P | 0.5 |
| | | | HALS | | | | | | | |
| 5 | C | Ex | — | — | Tinuvin | 0.5 | BB12P | 0.2 | Tinuvin P | 0.5 |
| | | | | | 770 | | | | | |

*: I = Inventive example/C = Comparative example
**: Ex = Extruder addition/D = Dispersion addition

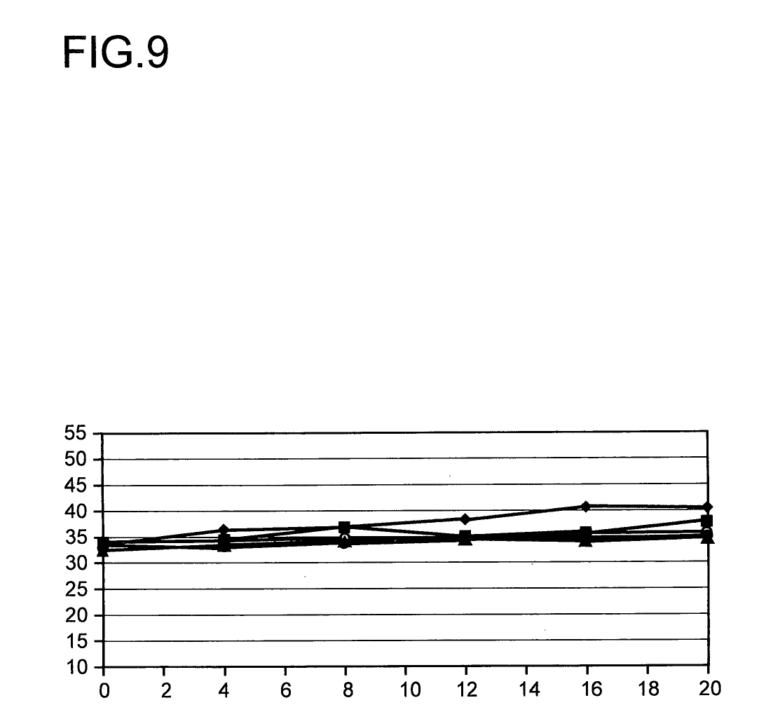

The inventive blends using PU-phenol-HALS, and also the comparative blend, are heat-aged (90° C.) for 20 weeks, and also irradiated with UV light for 400 h. The results are shown in FIGS. 9 to 12 and are given in table 6.

FIG. 9 shows yellowness index for PU-phenol-HALS after heat-aging at a temperature of 90° C. Aging time in weeks is shown on the abscissa, and yellowness index is shown on the ordinate. The following formulations are shown:

| | | |
|---|---|---|
| Square: | 114-2 | PU-phenol-HALS (0.5%) |
| Diamond: | 114-4 | PU-phenol-HALS (1.0%) |
| Triangle: | 114-3 | PU-phenol-HALS (0.25%) |
| Circle, light: | 114-5 | Tinuvin 770 (0.5%), BB12P (0.2%) |
| Circle, dark: | 114-12 | PU-phenol-HALS dispersion (0.5%) |

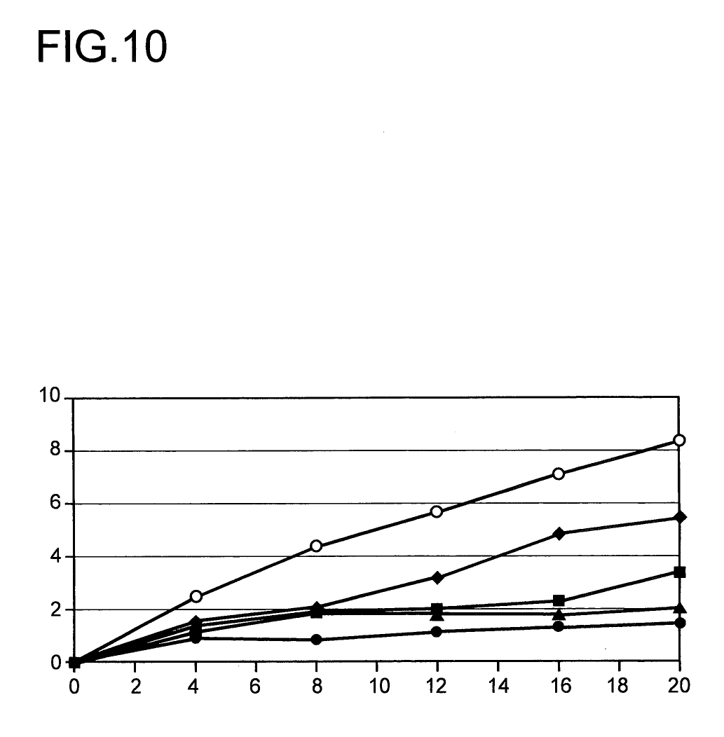

FIG. 10 shows the deviation value for PU-phenol-HALS after heat-aging at a temperature of 90° C. Aging time in weeks is shown on the abscissa, and deviation value is shown on the ordinate. The following formulations are shown;

| | | |
|---|---|---|
| Square: | 114-2 | PU-phenol-HALS (0.5%) |
| Diamond: | 114-4 | PU-phenol-HALS (1.0%) |
| Triangle: | 114-3 | PU-phenol-HALS (0.25%) |
| Circle, light: | 114-5 | Tinuvin 770 (0.5%), BB12P (0.2%) |
| Circle, dark: | 114-12 | PU-phenol-HALS dispersion (0.5%) |

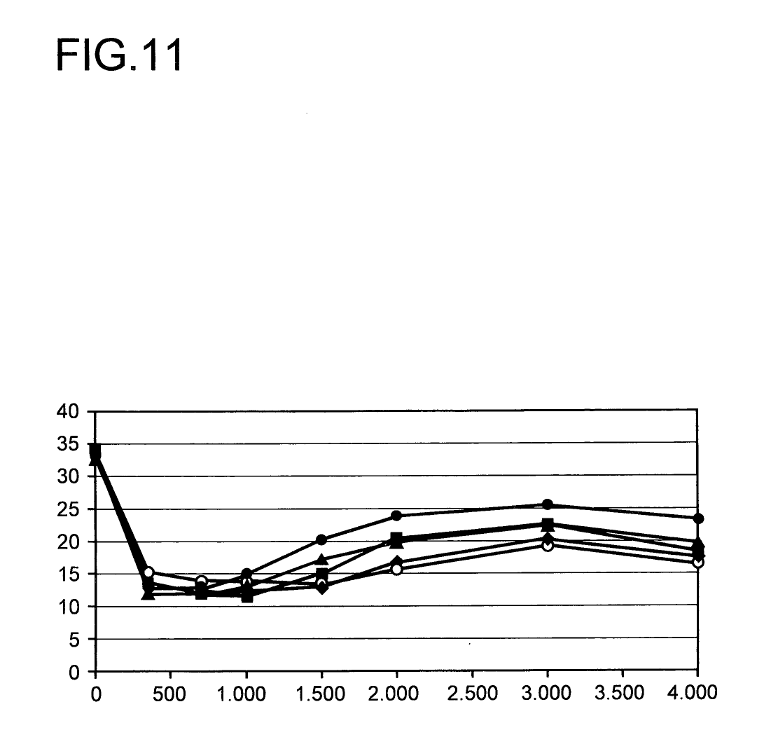

FIG. 11 shows the Xenotest 1200 CPS yellowness index for PU-phenol. Aging time in hours is shown on the abscissa and yellowness index is shown on the ordinate. The following formulations are shown:

| | | |
|---|---|---|
| Square: | 114-2 | PU-phenol-HALS (0.5%) |
| Diamond: | 114-4 | PU-phenol-HALS (1.0%) |
| Triangle: | 114-3 | PU-phenol-HALS (0.25%) |
| Circle, light: | 114-5 | Tinuvin 770 (0.5%), BB12P (0.2%) |
| Circle, dark: | 114-12 | PU-phenol-HALS dispersion (0.5%) |

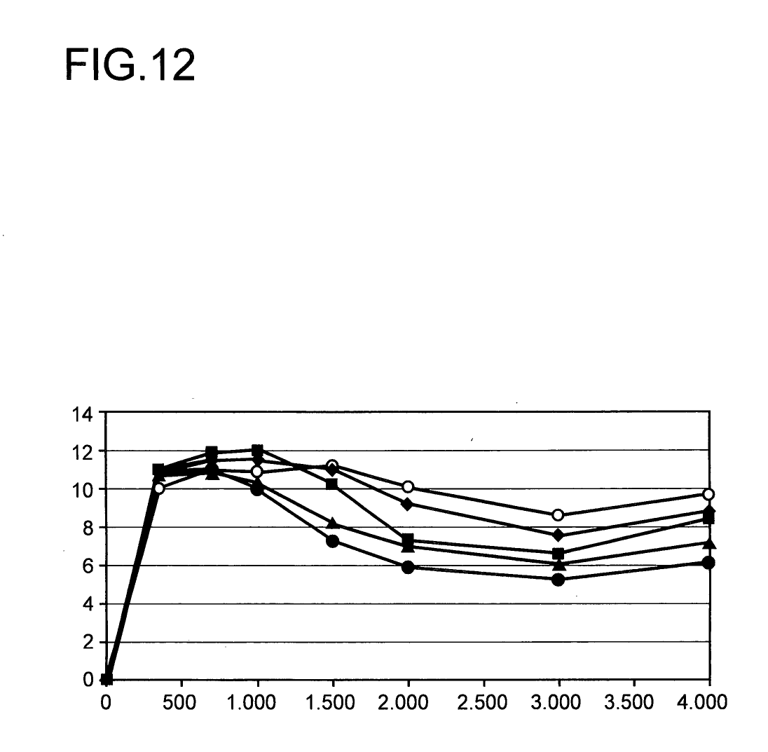

FIG. 12 shows the Xenotest 1200 CPS deviation value for PU-phenol. Aging time in hours is shown on the abscissa and deviation value is shown on the ordinate. The following formulations are shown:

| | | |
|---|---|---|
| Square: | 114-2 | PU-phenol-HALS (0.5%) |
| Diamond: | 114-4 | PU-phenol-HALS (1.0%) |
| Triangle: | 114-3 | PU-phenol-HALS (0.25%) |
| Circle, light: | 114-5 | Tinuvin 770 (0.5%), BB12P (0.2%) |
| Circle, dark: | 114-12 | PU-phenol-HALS dispersion (0.5%) |

In terms of yellowness index after heat-aging over 20 weeks, the effectiveness of the novel PU-phenol-HALS stabilizer proves to be similar to that of the comparative mixture using Tinuvin 770 and BB12P. On examining color deviation dE after heat-aging, markedly better action of PU-phenol-HALS is clearly seen (FIG. 10). Whereas the color deviation of the comparative example using Tinuvin 770 and BB12P is above 8 after 20 weeks at 90° C., the values for PU-phenol-HALS are from 1.4 to 5.4. The best dE result, 1.4, was achieved in the “dispersion” variant. The amount of stabilizer in this example, 0.5% by weight, was moreover even smaller than in the comparative example using 0.7% by weight (merely the total of Tinuvin 770 and BP12P). The variants in which the PU-phenol-HALS stabilizer was incorporated by mixing in the extruder also exhibit markedly better action than the comparative stabilizer mixture. In particular, the blend using 0.5% by weight exhibits very good action in terms of heat-aging, with dE 2.1, and is therefore also superior to the comparative example in relation to the amount used.

A similar picture is also apparent in the light-irradiation test. After irradiation with light for 4000 h, all of the blends are at a very similar level in terms of yellowness index, except for the dispersion variant of PU-phenol-HALS, which is somewhat higher than the comparative example. If color deviation dE is again examined, then again all of the blends using PU-phenol-HALS are better positioned than the comparative example (FIG. 12). The dispersion variant using 0.5% by weight of stabilizer exhibits the lowest color deviation (dE=6.1) after irradiation with light for 4000 hours. Incorporation of PU-phenol-HALS at a concentration of only 0.25% by weight by mixing in the extruder is likewise very effective, achieving color deviation of only 7.2. This is very effective stabilization, moreover achieved via a very small amount of stabilizer.

TABLE 6
Summary of stabilizing action of PU-phenol-HALS

| | | PU-phenol- | PU-phenol- | PU-phenol- | PU-phenol- |
|---|---|---|---|---|---|
| | | HALS | HALS | HALS | HALS |
| Amount of stabilizer | [% by weight] | 0.25 | 0.5 | 1.0 | 0.5 |
| used | | | | | |
| Added in | | Extruder | Extruder | Extruder | Dispersion |
| Mechanical | | ∘ | ∘ | ∘ | ∘ |
| properties | | | | | |
| Rheological | | ∘ | ∘ | ∘ | ∘ |
| properties | | | | | |
| UV aging | Yellowness | ∘ | ∘ | ∘ | − |
| | index YI | | | | |
| | Color dev. dE | ++ | + | + | ++ |
| Heat-aging | Yellowness | ∘ | ∘ | − | ∘ |
| | index YI | | | | |
| | Color dev. dE | ++ | ++ | ++ | ++ |

Scale:
++ very much better than comparative example
+ better than comparative example
∘ equivalent to comparative example
− poorer than comparative example
−− very much poorer than comparative example

1-14. (canceled)

15. A composition comprising:
(a) 5 to 70% by weight of at least one graft copolymer A;
(b) 30 to 90% by weight of a hard copolymer B, the percentages by weight based in each case on the at least one graft copolymer A and the hard copolymer B;
and at least one stabilizer;
wherein the at least one graft copolymer A comprises, based on the at least one graft copolymer A: (a1) 10 to 90% by weight of at least one elastomeric graft base having a glass transition temperature below 0° C.; and (a2) 10 to 90% by weight of at least one graft comprising, based on the at least one graft, 50 to 100% by weight of at least one styrene compound, 0 to 50% by weight of acrylonitrile, methacrylonitrile, or a mixture thereof, and 0 to 50% by weight of at least one other monoethylenically unsaturated monomer;
wherein the hard copolymer B comprises, based on the hard copolymer B, 50 to 100% by weight of at least one styrene compound, 0 to 50% by weight of acrylonitrile, methacrylonitrile, or a mixture thereof, and 0 to 50% by weight of at least one other monoethylenically unsaturated monomer;
and wherein the at least one stabilizer comprises one or more polyisocyanates having an average of 2 to 10 isocyanate groups per molecule, wherein at least one active ingredient group is coupled to the one or more polyisocyanates in an amount of 0.1 to 1.0 mole per mole of isocyanate groups, the at least one active ingredient group selected from phenolic compounds, sterically hindered amines and mixture thereof; and wherein up to 0.9 mole of one or more auxiliary groups is coupled to the one or more polyisocyanates.

16. A composition comprising:
(a) 5 to 70% by weight of at least one graft copolymer A;
(b′) 0 to 65% by weight of an alkyl methacrylate polymer B′;
(b″) 0 to 65% by weight of a copolymer B″, the percentages by weight based in each case on the at least one graft copolymer A, the alkyl methacrylate polymer B′ and the copolymer B″;
and at least one stabilizer;
wherein the at least one graft copolymer A comprises, based on the at least one graft copolymer A: (a1) 10 to 90% by weight of at least one elastomeric graft base having a glass transition temperature below 0° C.; and (a2) 10 to 90% by weight of at least one graft comprising, based on the at least one graft, up to 100% by weight of at least one compound selected from styrenes and alkyl methacrylates, 0 to 50% by weight of acrylonitrile, methacrylonitrile, or a mixture thereof, and 0 to 50% by weight of at least one other monoethylenically unsaturated monomer;
wherein the alkyl methacrylate polymer B′ is prepared by polymerizing a mixture comprising, based on the alkyl methacrylate polymer B′, 50 to 100% by weight of an alkyl methacrylate, 0 to 15% by weight of a C₁-C₈ alkyl acrylate, and 0 to 50% by weight of at least one other monoethylenically unsaturated monomer;
wherein the copolymer B″ is prepared by polymerizing a mixture comprising, based on the copolymer B″, 50 to 100% by weight of a vinylaromatic monomer, 0 to 50% by weight of acrylonitrile, methacrylonitrile, or a mixture thereof, and 0 to 50% by weight of at least one other monoethylenically unsaturated monomer;
and wherein the at least one stabilizer comprises one or more polyisocyanates having an average of 2 to 10 isocyanate groups per molecule, wherein at least one active ingredient group is coupled to the one or more polyisocyanates in an amount of 0.1 to 1.0 mole per mole of isocyanate groups, the at least one active ingredient group selected from phenolic compounds, sterically hindered amines and mixture thereof; and wherein up to 0.9 mole of one or more auxiliary groups is coupled to the one or more polyisocyanates.

17. The composition according to claim 15, further comprising at least one additional additive, in an amount up to 5% based on the composition, selected from the group consisting of:
(c) three-block copolymers of the general formula X-Y-X having a middle block Y comprised of propylene oxide units and terminal X blocks comprised of ethylene oxide units;
(d) butylated reaction products of p-cresol and a dicyclopentadiene of the general formula (I): 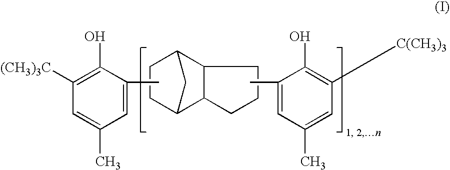
wherein n represents a number less than or equal to 10;
(e) thiocarboxylic esters; and
(f) alkali and alkaline earth metal salts of C₆₋₂₀ carboxylic acids.

18. The composition according to claim 16, further comprising at least one additional additive, in an amount up to 5% based on the composition, selected from the group consisting of:
(c) three-block copolymers of the general formula X-Y-X having a middle block Y comprised of propylene oxide units and terminal X blocks comprised of ethylene oxide units;
(d) butylated reaction products of p-cresol and a dicyclopentadiene of the general formula (I): 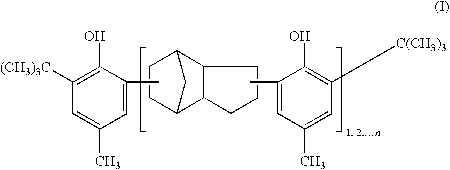
wherein n represents a number less than or equal to 10;
(e) thiocarboxylic esters; and
(f) alkali and alkaline earth metal salts of C₆₋₂₀ carboxylic acids.

19. The composition according to claim 15, wherein the at least one elastomeric graft base comprises, based on the at least one elastomeric graft base: 60 to 100% by weight of at least one monomer selected from the group consisting of conjugated dienes, C₁-C₁₀ alkyl acrylates, and mixtures thereof; 0 to 35% by weight of at least one other monoethylenically unsaturated monomer; and 0 to 10% by weight of at least one crosslinking monomer.

20. The composition according to claim 16, wherein the at least one elastomeric graft base comprises, based on the at least one elastomeric graft base: 60 to 100% by weight of at least one monomer selected from the group consisting of conjugated dienes, C₁-C₁₀ alkyl acrylates, and mixtures thereof; 0 to 35% by weight of at least one other monoethylenically unsaturated monomer; and 0 to 10% by weight of at least one crosslinking monomer.

21. The composition according to claim 17, wherein the at least one elastomeric graft base comprises, based on the at least one elastomeric graft base: 60 to 100% by weight of at least one monomer selected from the group consisting of conjugated dienes, C₁-C₁₀ alkyl acrylates, and mixtures thereof; 0 to 35% by weight of at least one other monoethylenically unsaturated monomer; and 0 to 10% by weight of at least one crosslinking monomer.

22. The composition according to claim 18, wherein the at least one elastomeric graft base comprises, based on the at least one elastomeric graft base: 60 to 100% by weight of at least one monomer selected from the group consisting of conjugated dienes, C₁-C₁₀ alkyl acrylates, and mixtures thereof; 0 to 35% by weight of at least one other monoethylenically unsaturated monomer; and 0 to 10% by weight of at least one crosslinking monomer.

23. A process for preparing the composition according to claim 15, the process comprising:
(a) forming the at least one graft copolymer A by emulsion polymerization of the at least one elastomeric graft base (a1) and the at least one graft (a2);
(b) mixing the at least one graft copolymer A, the hard copolymer B and the at least one stabilizer to form a substantially molten polymer mixture; and
(c) cooling the substantially molten polymer mixture in a period of 10 seconds or less.

24. A process for preparing the composition according to claim 16, the process comprising:
(a) forming the at least one graft copolymer A by emulsion polymerization of the at least one elastomeric graft base (a1) and the at least one graft (a2);
(b) mixing the at least one graft copolymer A, the alkyl methacrylate polymer B′ and/or the copolymer B″, and the at least one stabilizer to form a substantially molten polymer mixture; and
(c) cooling the substantially molten polymer mixture in a period of 10 seconds or less.

25. The process according to claim 23, wherein the composition further comprises at least one additional additive, in an amount up to 5% based on the composition, selected from the group consisting of:
(d) butylated reaction products of p-cresol and a dicyclopentadiene of the general formula (I): 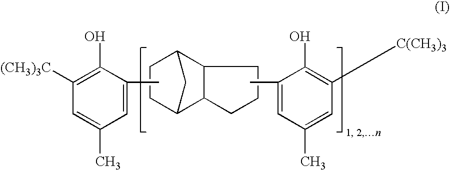
wherein n represents a number less than or equal to 10; and
(e) thiocarboxylic esters;
and wherein at least a portion of the at least one additional additive is added prior to mixing, and any remaining portion of the at least one additional additive is added prior to cooling.

26. The process according to claim 24, wherein the composition further comprises at least one additional additive, in an amount up to 5% based on the composition, selected from the group consisting of:
(d) butylated reaction products of p-cresol and a dicyclopentadiene of the general formula (I): 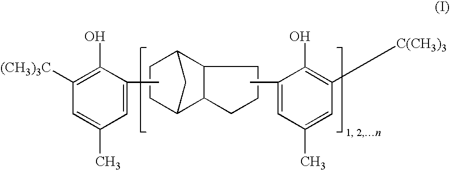
wherein n represents a number less than or equal to 10; and
(e) thiocarboxylic esters;
and wherein at least a portion of the at least one additional additive is added prior to mixing, and any remaining portion of the at least one additional additive is added prior to cooling.

27. An article selected from the group consisting of moldings, fibers, foils and combinations thereof, wherein the article comprises a composition according to claim 15.

28. An article selected from the group consisting of moldings, fibers, foils and combinations thereof, wherein the article comprises a composition according to claim 16.

29. A method comprising (a) providing a composition according to claim 15; and (b) processing the composition to form an article selected from the group consisting of moldings, fibers, foils and combinations thereof.

30. A method comprising (a) providing a composition according to claim 16; and (b) processing the composition to form an article selected from the group consisting of moldings, fibers, foils and combinations thereof.
